(19) United States
(12) Patent Application Publication
(10) Pub. No.: US 2025/0062316 A1
(43) Pub. Date: Feb. 20, 2025

(54) PATTERNED ANODES FOR LITHIUM-BASED ENERGY STORAGE DEVICES

(71) Applicant: GRAPHENIX DEVELOPMENT, INC., Williamsville, NY (US)

(72) Inventors: Terrence R. O'Toole, Williamsville, NY (US); John C. Brewer, Williamsville, NY (US); Paul D. Garman, Williamsville, NY (US); Robert G. Anstey, Williamsville, NY (US); Kevin Tanzil, Williamsville, NY (US)

(73) Assignee: GRAPHENIX DEVELOPMENT, INC., Williamsville, NY (US)

(21) Appl. No.: 18/719,746

(22) PCT Filed: Dec. 17, 2021
(86) PCT No.: PCT/US2021/064018

§ 371 Date: Jun. 13, 2024

(51) Int. Cl. H01M 4/134; H01M 4/02; H01M 4/38; H01M 4/48; H01M 4/62; H01M 4/66

(52) U.S. Cl. CPC H01M 4/134; H01M 4/386; H01M 4/483; H01M 4/62; H01M 4/621; H01M 4/628; H01M 4/661; H01M 4/662; H01M 4/667; H01M 2004/021; H01M 2004/027

(57) ABSTRACT

An anode for an energy storage device includes a current collector having an electrically conductive layer, a first surface characterized by a first pattern, and a second surface characterized by a complementary second pattern. The anode further includes a patterned lithium storage structure comprising a continuous porous lithium storage layer disposed over the current collector in a pattern corresponding to the first pattern. A method of making an anode for use in an energy storage device includes providing a current collector having an electrically conductive layer, a first surface characterized by a first pattern, and a second surface characterized by a complementary second pattern. A continuous porous lithium storage layer is formed by chemical vapor deposition over the first surface by exposing the current collector to a lithium storage material precursor gas.

### TECHNICAL FIELD

The present disclosure relates to lithium-ion batteries and related energy storage devices.

### BACKGROUND

Silicon has been proposed for lithium-ion batteries to replace the conventional carbon-based anodes, which have a storage capacity that is limited to ˜370 mAh/g. Silicon readily alloys with lithium and has a much higher theoretical storage capacity (˜3600 to 4200 mAh/g at room temperature) than carbon anodes. However, insertion and extraction of lithium into the silicon matrix causes significant volume expansion (>300%) and contraction. This can result in rapid pulverization of the silicon into small particles and electrical disconnection from the current collector.

The industry has recently turned its attention to nano- or micro-structured silicon to reduce the pulverization problem, i.e., silicon in the form of spaced apart nano- or micro-wires, tubes, pillars, particles, and the like. The theory is that making the structures nano-sized avoids crack propagation and spacing them apart allows more room for volume expansion, thereby enabling the silicon to absorb lithium with reduced stresses and improved stability compared to, for example, macroscopic layers of bulk silicon.

Despite research into various approaches, batteries based primarily on silicon have yet to make a large market impact due to unresolved problems.

### SUMMARY

There remains a need for anodes for lithium-based energy storage devices such as Li-ion batteries that are easy to manufacture, robust to handling, high in charge capacity amenable to fast charging, for example, at least 1 C, and that are resistant to dimensional changes.

In accordance with an embodiment of this disclosure, an anode for an energy storage device includes a current collector having an electrically conductive layer, a first surface characterized by a first pattern, and a second surface characterized by a complementary second pattern. The anode further includes a patterned lithium storage structure comprising a continuous porous lithium storage layer disposed over the current collector in a pattern corresponding to the first pattern.

In accordance with another embodiment of this disclosure, a method of making an anode for use in an energy storage device includes providing a current collector having an electrically conductive layer, a first surface characterized by a first pattern, and a second surface characterized by a complementary second pattern. A continuous porous lithium storage layer is formed by chemical vapor deposition over the first surface by exposing the current collector to a lithium storage material precursor gas.

The present disclosure provides anodes for energy storage devices that may have one or more of at least the following advantages relative to conventional anodes: improved stability at aggressive ≥1 C charging rates; higher overall areal charge capacity; higher charge capacity per gram of lithium storage material (e.g., silicon); improved physical durability; simplified manufacturing process; more reproducible manufacturing process; or reduced dimensional changes during operation.

### BRIEF DESCRIPTION OF DRAWINGS

FIGS. 1A-1C are a series of plan views illustrating a method of making a patterned anode according to some embodiments of the present disclosure.

FIGS. 1D-1F are a series of cross-sectional views taken along cutline A-A and corresponding to FIGS. 1A-1C.

FIGS. 2A-2F are cross-sectional views illustrating current collectors according to some embodiments of the present disclosure.

FIGS. 3A-3C are series of cross-sectional views illustrating a method of making a current collector according to some embodiments of the present disclosure.

FIGS. 4A-4B are cross-sectional views illustrating current collectors according to some embodiments of the present disclosure.

FIGS. 5A-5C are cross-sectional views illustrating current collectors according to some embodiments of the present disclosure.

FIG. 6 is a cross-sectional view illustrating a continuous porous lithium storage layer over a first surface of a current collector having a surface layer that includes a plurality of surface sublayers.

FIG. 7 is a cross-sectional view of a prior art anode that includes some examples of nanostructures.

FIG. 8 is a cross-sectional view of a continuous porous lithium storage layer according to some embodiments of the present disclosure.

FIGS. 9A-9G are plan views of anodes having variously patterned lithium storage structures according to some embodiments of the present disclosure.

FIG. 10 is a plan view illustrating a radial distance when determining a critical dimension of a first region of a patterned lithium storage structure.

FIGS. 11A-11B are a series of cross-sectional views illustrating anode deformation during electrochemical cycling.

FIG. 12 is a cross-sectional view illustrating an anode with a current collector having a second surface that is recessed relative to a first surface according to some embodiments of the present disclosure.

FIG. 13 is a cross-sectional view illustrating an anode with a current collector having a first surface that is recessed relative to a second surface according to some embodiments of the present disclosure.

FIG. 14 is a cross-sectional view illustrating an anode having first and second continuous porous lithium storage layer according to some embodiments of the present disclosure.

FIGS. 15A-15C are cross-sectional views illustrating the formation of a patterned lithium storage structure including lithium storage nanowires according to some embodiments of the present disclosure.

FIGS. 16A and 16B are cross-sectional views showing the patterned lithium storage structure and a functional composition according to some embodiments of the present disclosure.

### DETAILED DESCRIPTION

It is to be understood that the drawings are for purposes of illustrating the concepts of the disclosure and may not be to scale. Additional details of certain embodiments of the present disclosure may be found in co-pending U.S. patent application Ser. No. 16/991,613 and in U.S. Pat. No. 11,024,842, the entire contents of which are incorporated herein by reference for all purposes. Terms like “overlaying”, “over” or the like include, but do not necessarily require, direct contact (unless such direct contact is noted or clearly required for functionality).

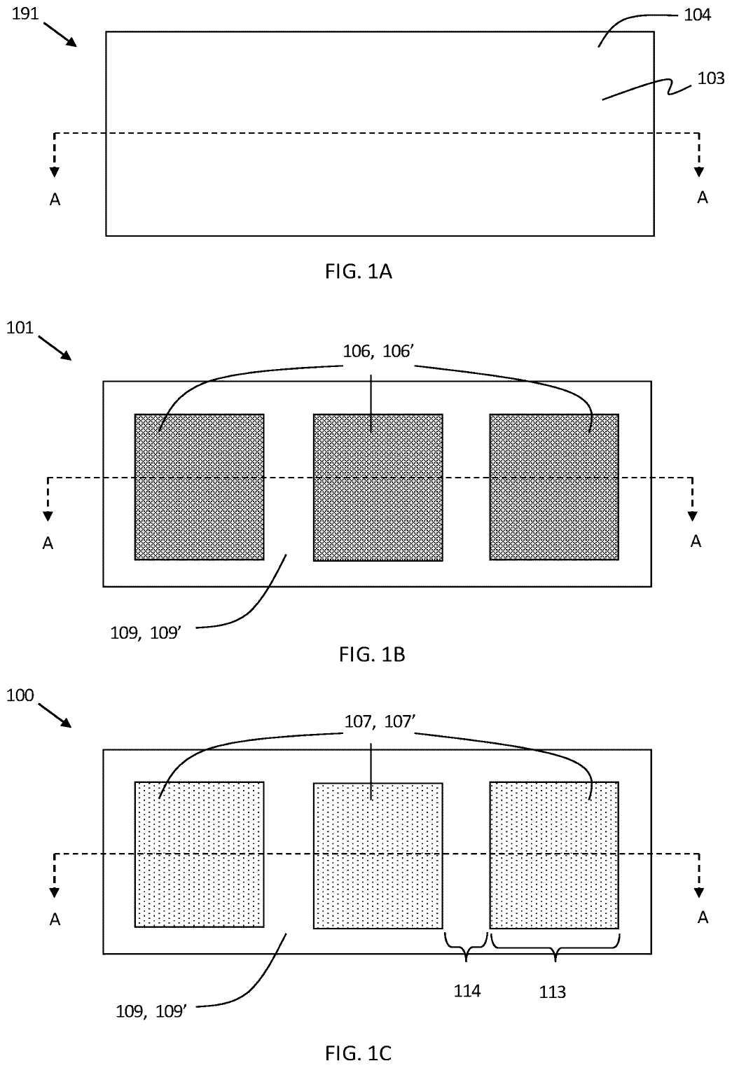

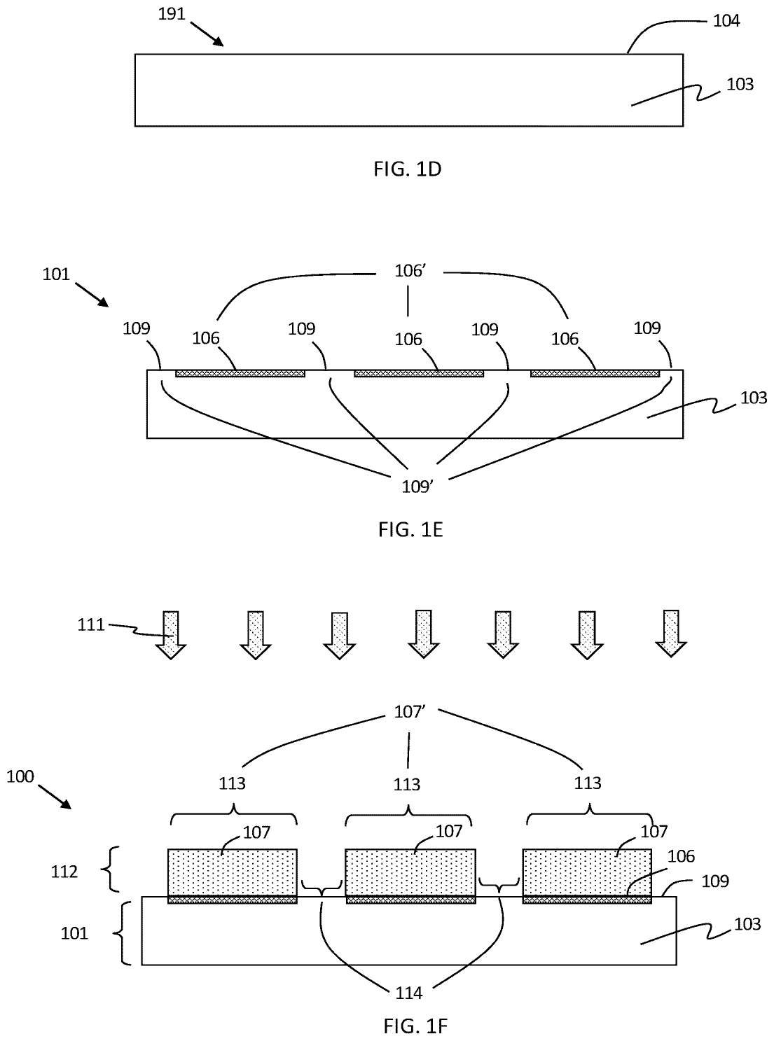

FIGS. 1A-1C are a series of plan views illustrating a method of making a patterned anode according to some embodiments of the present disclosure. FIGS. 1D-1F are corresponding cross-sectional views taken along cutline A-A. In FIGS. 1A and 1D, current collector precursor 191 is provided which includes at least an electrically conductive layer 103 having a surface 104. Details of the electrically conductive layer are discussed later, but in some embodiments may be in the form of a metal foil and surface 104 represents one side of the foil.

As shown in FIGS. 1B and 1F, the method includes treating the electrically conductive layer 103 to pattern-wise modify the surface 104, thereby forming a current collector 101 having a first surface 106 characterized by a first pattern 106′ and having a second surface 109 characterized by a complementary second pattern 109′. First surface 106 and second surface 109 refer to the physical material, and first pattern 106′ and second pattern 109′ refer to the patterns of the respective material. For example, a material different than the material in first surface 106 may be characterized by first pattern 106′. The chemical composition, the physical properties, or both the chemical composition and the physical properties of the first surface may be different than those of the second surface.

In FIGS. 1C and 1F, a continuous porous lithium storage layer 107 is formed over the current collector in a pattern 107′ corresponding to the first pattern, by a chemical vapor deposition (CVD) process, using one or more appropriate lithium storage material precursor gases 111 and conditions. In the present embodiment, anode 100 is provided having a patterned lithium storage structure 112 formed over current collector 101. The patterned lithium storage structure 112 includes one or more first regions 113 having a continuous porous lithium storage layer 107 including a first lithium storage material generally overlaying the first surface 106 and further includes one or more second regions 114 corresponding to the second pattern 109′ substantially free of the continuous porous lithium storage layer in this embodiment. In some embodiments, “substantially free of the continuous porous lithium storage layer” may mean that the second pattern has less than 10% of the areal density of lithium storage layer material (e.g., in terms of mg/cm² of lithium storage material) than the areal density of the lithium storage layer material in the first pattern, alternatively less than 5%, alternatively less than 2%, alternatively less than 1%, or alternatively less than 0.5%.

The properties of the first surface promote adherent formation of the continuous porous lithium storage layer by the CVD deposition method. In some embodiments, different areas of the first pattern and first surface may have differing compositional or physical properties, or the first pattern may even include a sub-pattern, so long as the first surface promotes adherent formation of the continuous porous lithium storage layer. In some embodiments, the properties of the second surface may be selected to i) kinetically or thermodynamically inhibit formation of the continuous porous lithium storage layer in the second pattern, ii) inhibit adhesion of any lithium storage material deposited by the CVD process in the second pattern making such material easy to remove, iii) promote formation of a lithium storage material different than a continuous porous lithium storage layer including, but not limited to, silicon-containing nanowires, or iv) provide a compliant or stress-absorbing interface for a second continuous porous lithium storage layer. In some cases, the properties of the second surface are selected to achieve a combination of effects such effects. In some embodiments, different areas of the second pattern and second surface may have differing compositional or physical properties, or the second pattern may even include a sub-pattern, so long as the second surface displays one or more of properties i) through iv).

### Current Collector

### Surface Roughening

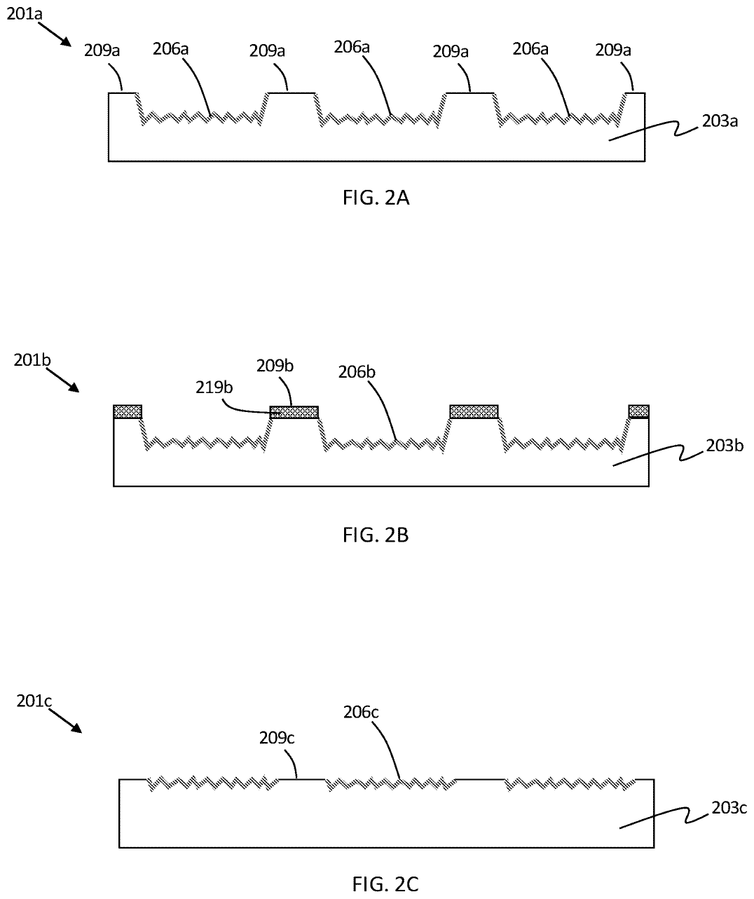

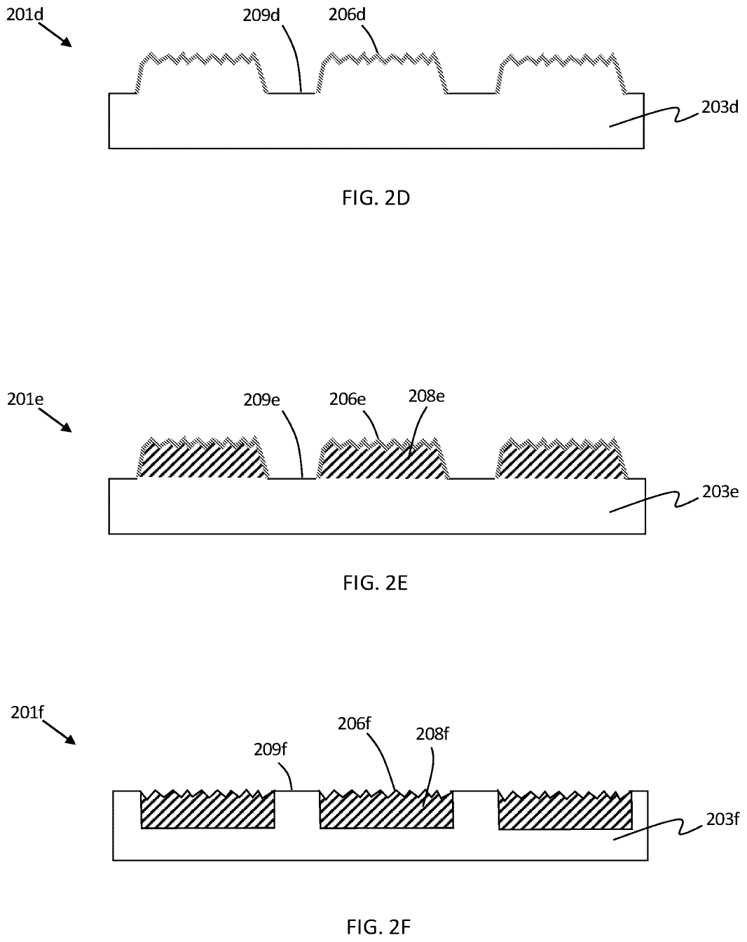

In some embodiments, a surface roughening step may be applied to the current collector precursor, for example, to the surface of the electrically conductive layer, so that the first surface may have a roughness higher than the second surface. In some embodiments, the increased roughness may also promote the formation of an adherent continuous porous lithium storage layer in the first pattern. In some embodiments as shown in FIG. 2, the roughness is incorporated directly into the electrically conductive layer. Roughening of the electrically conductive layer may include, for example, physical abrasion (such as sandpaper, sand blasting, or the like), ablation (such as by laser ablation), embossing, chemical treatments, electrochemical treatments, or thermal treatments. FIG. 2A is a cross-sectional view similar to FIG. 1E illustrating a current collector 201a having higher surface roughness in first surface 206a than second surface 209a. In FIG. 2A, surface 206a is generally recessed relative to surface 209a. First surface 206a, may for example, be formed by an embossing method using a die having rough pattern corresponding to the first pattern. Alternatively, a patterned laser ablation method may be used. Alternatively, a chemical roughening agent, e.g., a metal etchant, may be applied in a first pattern.

In some embodiments, when a roughening process is not easily provided in a pattern, a resist or other roughening-resistant layer may be first applied over the second surface to protect the second surface from roughening step. Such a resist may be applied by printing or by photolithography followed by the roughing, e.g., by treatment with a chemical roughening agent or an electrochemical roughening process. In some embodiments, the resist may be removed, or alternatively, as shown in FIG. 2B, the roughening resistant layer 219b may remain over electrically conductive layer 203b as part of the current collector 201b and form part of surface 209b in a second pattern complementary to the first pattern of first surface 206b. For clarity, only one of each feature is labeled in FIG. 2B. Depending on the desired anode structure, the roughening resistant layer may be electrically conductive or electrically insulating, and may optionally be selected to form a second surface having one or more of properties (i), (ii), (iii), and (iv) described above.

In some embodiments as shown in FIG. 2C, the current collector 201c may include electrically conductive layer 203c, first surface 206c and second surface 209c where the first surface is not substantially recessed relative to the second surface 209c. For clarity, only one of each feature is labeled in FIG. 2C. Similar methods can be used as previously described. In some case, the conditions may be altered so as not to form the recess. For example, lower pressure during embossing, shorter or less energetic physical abrasion or laser ablation, or milder or alternative chemical or electrochemical treatments. In some embodiments, the electrically conductive layer may include a metal layer and a chemical treatment may include a first reaction to form a metal compound (e.g., an insoluble metal salt) and a second reaction to reform a metal, e.g., by chemical reduction. The final surface after such a sequence may have significantly higher roughness. Alternatively, electrochemical methods which include cycles of oxidation and reduction may increase surface roughness. In some cases, these methods may employ a resist or a roughening resistant layer in the second pattern as described previously for FIG. 2B, but not shown here. In some embodiments, a combination of roughening surface treatments may be used.

In some embodiments as shown in FIG. 2D, the current collector 201d may include electrically conductive layer 203d, first surface 206d and second surface 209d where the first surface is raised relative to the second surface 209d. For clarity, only one of each feature is labeled in FIG. 2D. There are numerous ways to prepare current collector 201d. In some embodiments, the electrically conductive layer of the current collector precursor may be provided with, or patterned to produce, raised features on its surface corresponding to the first pattern followed by one of the roughening methods previously described. For example, the raised portions may be roughened using physical abrasion, ablation, chemical treatments, or electrochemical treatments, optionally in conjunction with a resist or a roughening resistant layer in the second pattern similar to that described previously for FIG. 2B, but not shown here. Methods of making the current collector precursor having raised features may include, for example, using a resist in conjunction with electroforming or electroplating.

In some embodiments the current collector includes an electrically conductive roughening layer over the electrically conductive layer. For example, as shown in FIG. 2E, current collector 201e may include electrically conductive layer 203e and an electrically conductive roughening layer 208e that may have a different chemical composition than the electrically conductive layer. Electrically conductive roughening layer 208e may be provided in the first pattern and corresponds to first surface 206e of current collector 201e, and areas between the roughening layer correspond to the second surface 209e having a lower surface roughness.

There are numerous ways to prepare current collector 201e. In some embodiments, an electrically conductive layer precursor composition may be printed and optionally cured. The precursor composition may include, for example, conductive particles such as conductive carbon, copper or silver particles that coalesce or sinter to form particulate structures having high roughness. In some embodiments, the conductive particles may take the form of nanowires or nanotubes.

In some embodiments, the electrically conductive roughening layer 208e may be electroplated onto the electrically conductive layer 203e. Some electroplating solutions and conditions are known to produce a rough electrically conductive surface. To form a pattern, a resist may be first applied to the surface of the electrically conductive layer in the second pattern and electroplating of the roughening layer selectively occurs in the first pattern. Alternatively, the electrically conductive roughening layer may first be electroplated over the entire surface of the electrically conductive layer followed by a patterned etching step. For example, a resist may be applied in a first pattern and the electrically conductive roughening layer is etched in the second pattern.

In some embodiments, the electrically conductive roughening layer includes electrodeposited copper nodules or nanopillars. For instance, an electrically conductive layer (e.g., a copper, nickel, titanium, or stainless-steel foil or mesh) may be provided into a first acid copper plating solution having 50 to 250 g/L of sulfuric acid and less than 10 g/L copper provided as copper sulfate. Copper particles may be deposited at room temperature by cathodic polarization of electrically conductive layer and applying a current density of about 0.1 to 0.3 A/cm² for a few seconds to a few minutes. In some embodiments, the electrically conductive layer may next be provided into a second acid copper plating solution having 50 to 200 g/L of sulfuric acid and greater than 50 g/L copper provided as copper sulfate. The second acid copper bath may be warmed to temperature of about 30° C. to 50° C. A thin copper layer may be electroplated at over the copper particles to secure the particles to the electrically conductive layer by cathodic polarization and applying a current density of about 0.05 to 0.2 A/cm² for a few seconds to a few minutes. There are many other methods and conditions useful for electroplating a rough electrically conductive surface.

In some embodiments, the electrically conductive roughening layer 208e may be deposited by electroless plating onto the electrically conductive layer. In some embodiments, electroless plating may employ a catalyst applied to the surface of the electrically conductive layer 203e followed by immersion in an electroless plating bath. Many electroless plating baths are known to deposit a rough electrically conductive layer especially if planarizing additives are removed from the solution. Similar patterning methods that employ a resist may be used as described above for electroplating. In another embodiment, the catalyst may be applied in a pattern corresponding to the first pattern. Immersion in the electroless plating bath will then selectively form the electrically conductive roughening layer 208e in the first pattern.

In some embodiments, as shown in FIG. 2F, the electrically roughening layer 208f, may be deposited by printing, electroplating, or electroless plating into a first pattern of recesses of the electrically conductive layer 203f to form current collector 201f having first surface 206f with a higher surface roughness than second surface 209f. Although FIG. 2F shows surface 206f in about the same plane as surface 209f, the electrically roughening layer 208f may instead be provided so that surface 206f is recessed or raised relative to surface 209c.

Throughout this disclosure and unless otherwise noted, the term “electroless plating” includes either or both of i) catalyzed deposition as described above, or ii) so-called immersion plating where a reagent in solution replaces a material at a surface, e.g., the surface of the electrically conducive layer, by a redox exchange process.

Although not shown, any of the current collector embodiments of FIG. 2 may include one or more surface layers. Patterned surface layers are discussed below but such surface layers may optionally be applied over the structures of FIG. 2 in both the high surface roughness and low surface roughness portions.

Although not shown in FIG. 2, in a subsequent step, a patterned lithium storage structure may be formed including a continuous porous lithium storage layer provided by a CVD process over the first surface in accordance with embodiments similar to those shown in FIG. 1.

### Polishing

Rather than, or in addition to, patterned roughening treatments, methods of making any of the current collectors of FIG. 2 may include a patterned polishing or smoothing step on a rough surface to form a second surface having lower surface roughness. Such polishing may include mechanical methods, chemical methods, or a combination of both, commonly called “chem-mech polishing”. Alternatively, or in addition to the above methods, electropolishing technology may be used to smoothen the second surface.

### Planarizing Layer

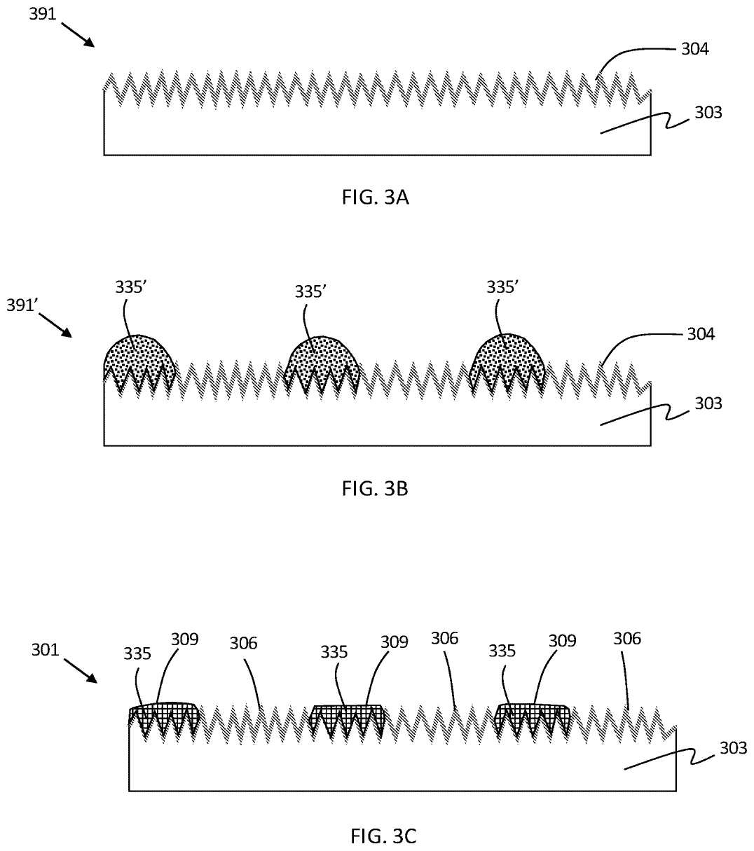

As shown in FIG. 3, first and second surfaces having different roughness may be provided by using a planarizing layer. FIG. 3A is a cross-sectional view of a current collector precursor 391 including electrically conductive layer 303 having a surface 304 which is rough. In FIG. 3B, a planarizing material 335′ is pattern applied in areas corresponding to the desired second pattern to form second current collector precursor 391′. Pattern application may be done by printing or by lithography. In some embodiments, the planarizing material may undergo a curing step to drive off solvents or induce cross linking to form current collector 301 having a first surface 306 characterized by a first pattern and second surface 309 formed by planarizing layer 335 provided over the electrically conductive layer in a pattern corresponding to the second pattern. Curing may include heating such as in an oven or treatment with an IR flash lamp. In some embodiments, depending on the desired anode structure, the planarization layer may be electrically conductive or electrically insulating, and may optionally be selected to form a second surface having one or more of properties (i), (ii), (iii), and (iv) described above. In some embodiments, the planarization layer is formed of a material that does not deleteriously decompose under CVD deposition conditions. In some embodiments, the planarization layer may include a thermally stable polymer, an inorganic sol-gel, or sintered metal nanoparticles. In some embodiments, the planarizing layer and planarizing material may instead be referred to as a smoothing layer and smoothing material, respectively, where the second surface may not be entirely planar, but is still less rough than the first surface.

Although not shown in FIG. 3, in a subsequent step, a patterned lithium storage structure may be formed including a continuous porous lithium storage layer provided by a CVD process over the first surface in accordance with embodiments similar to those shown in FIG. 1.

In some embodiments, the first surface has a higher roughness than the second surface. Herein, surface roughness comparisons and measurements may be made using the Roughness Average (Rₐ), RMS Roughness (Rq), Maximum Profile Peak Height roughness (Rₚ), Average Maximum Height of the Profile (R_{z}), or Peak Density (P_{c}). The ratio of the second surface roughness to the first surface roughness may be less than 0.8, alternatively less than 0.7, alternatively less than 0.6, alternatively less than 0.5, alternatively less than 0.4, alternatively less than 0.3, alternatively less than 0.2, or alternatively less than 0.1. In some embodiments the first surface is characterized by a roughness R_{z} in a range of 2.0-2.5 μm, alternatively 2.5-3.0 μm, alternatively 3.0-3.5 μm, alternatively 3.5-4.0 μm, alternatively 4.0-4.5 μm, alternatively 4.5-5.0 μm, alternatively 5.0-5.5 μm, alternatively 5.5-6.0 μm, alternatively 6.0-6.5 μm, alternatively 6.5-7.0 μm, alternatively 7.0-8.0 μm, alternatively 8.0-9.0 μm, alternatively 9.0 to 10.0 μm, or any combination of contiguous ranges thereof. In some embodiments the first surface is characterized by a roughness Rₐ in a range of 0.20-0.25 μm, alternatively 0.25-0.30 μm, alternatively 0.30-0.35 μm, alternatively 0.35-0.40 μm, alternatively 0.40-0.45 μm, alternatively 0.45-0.50 μm, alternatively 0.50-0.55 μm, alternatively 0.55-0.60 μm, alternatively 0.60-0.65 μm, alternatively 0.65-0.70 μm, alternatively 0.70-0.80 μm, alternatively 0.80-0.90 μm, alternatively 0.90-1.0 μm, or any combination of contiguous ranges thereof. In some embodiments, the first surface may be characterized as having both a surface roughness R_{z}≥2.5 μm and a surface roughness Rₐ≥0.25 μm.

In FIGS. 2-3, the surface roughness is illustrated as having uniform jagged or sharp features. However, many surface morphologies may provide the above desired roughness. For example, the roughness may be in the form of nodules or pillars, such as may be provided by certain electroplating or electroless plating methods. Rather than uniform, the roughening features may be random or variable across a surface.

Electrically Conductive Layer In some embodiments the electrically conductive layer may have a conductivity of at least 10³ S/m, or alternatively at least 10⁶ S/m, or alternatively at least 10⁷ S/m, and may include inorganic or organic conductive materials or a combination thereof. In some embodiments, the electrically conductive layer includes a metallic material, e.g., titanium (and its alloys), nickel (and its alloys), copper (and its alloys), or stainless steel. In some embodiments, the electrically conductive layer includes an electrically conductive carbon, such as carbon black, carbon nanotubes, graphene, graphene oxide, reduced graphene oxide, and graphite. In some embodiments the electrically conductive layer may be in the form of a foil, a mesh, or sheet of conductive material. Herein, a “mesh” includes any electrically conductive structure having openings such as found in interwoven wires, foam structures, foils with an array of holes, or the like. In some embodiments, the electrically conductive layer may include multiple layers of different electrically conductive materials. The electrically conductive layer may be in the form of a layer deposited onto an insulating substrate (e.g., a polymer sheet or ceramic substrate coated with a conductive material, including but not limited to, nickel or copper, optionally on both sides). In some embodiments, the electrically conductive layer includes a mesh or sheet of electrically conductive carbon, including but not limited to, those formed from bundled carbon nanotubes or nanofibers. In some embodiments, such carbon-based electrically conductive layers may include a surface layer of a conductive metal, e.g., nickel, copper, zinc, titanium or the like. In some embodiments, the conductive metal surface layer may be applied by electrolytic or electroless plating methods.

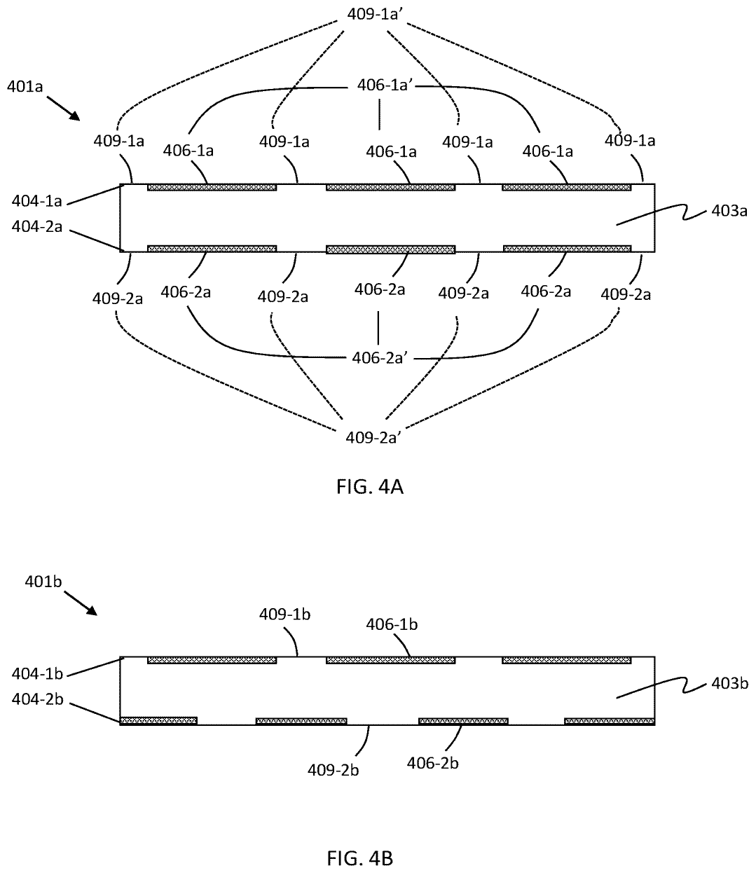

The electrically conductive layer may have two sides, each having its own set of first and second surfaces. For example, FIG. 4A shows a cross-sectional view of current collector 401a including electrically conductive layer 403a having a first side 404-1a and second side 404-2a. On the first side of the electrically conductive layer, the current collector includes a first surface 406-1a characterized by the first pattern 406-1a′ and a second surface 409-1a characterized by a second pattern 409-1a′ complementary to the first pattern. On the second side of the electrically conductive layer, the current collector includes a first surface 406-2a characterized by the first pattern 406-2a′ and a second surface 409-2a characterized by a second pattern 409-2a′ complementary to the first pattern.

Although shown as symmetrical, the patterns, physical properties, or chemical properties, or a combination thereof, of the first and second surfaces on the first and second sides may be different. For example, FIG. 4B shows a cross-sectional view of current collector 401b including electrically conductive layer 403b having a first side 404-1b and second side 404-2b. On the first side of the electrically conductive layer, the current collector includes a first surface 406-1b characterized by the first pattern and a second surface 409-1b characterized by a second pattern complementary to the first pattern. On the second side of the electrically conductive layer, the current collector includes a first surface 406-2b characterized by the first pattern and a second surface 409-2b characterized by a second pattern complementary to the first pattern. For clarity, only one of each feature is labeled in FIG. 4B. In FIG. 4B, the first and second patterns of the first side are clearly different than the first and second patterns of the second side. In some embodiments, the first and second patterns of the first side may be exactly out-of-phase with the first and second patterns of the second side. In some cases, the first surface of the first side may include a higher, lower, or the same roughness than the first surface of the second side. In some cases the first surface of the first side may have a chemical composition different than the first surface of the second side. In some cases, the second surface of the first side may include a higher lower, or the same roughness than the second surface of the second side. In some cases the second surface of the first side may have a chemical composition different than the second surface of the second side. In some embodiments, one side may include a surface layer (discussed below) and the other side may not, or alternatively include a surface layer having a different chemical composition.

### Tensile Strength

In some embodiments, the electrically conductive layer may be characterized as having a yield strength. If the yield strength is too high or too low, it may be difficult to handle in manufacturing such as in roll-to-roll processes. During electrochemical cycling of the anode, deformation of the anode may occur if the yield strength is too low, or alternatively, adhesion of the continuous porous lithium storage layer may be compromised if the yield strength is too high. In some embodiments, methods of the present invention may widen the latitude of acceptable yield strength to meet these various needs. In some cases, the tensile yield strength may be relatively low such as less than about 350 MPa, or relatively high such as greater than 350 MPa. In some embodiments, the tensile yield strength of the electrically conductive layer may be in a range of 25-50 MPa, alternatively 50-100 MPa, alternatively 100-150 MPa, alternatively 150-200 MPa, alternatively 200-250 MPa, alternatively 250-300 MPa, alternatively 300-350 MPa, alternatively 350-400 MPa, alternatively 400-500 MPa, alternatively 500-600 MPa, alternatively 600-700 MPa, alternatively 700-800 MPa, alternatively 800-900 MPa, alternatively 900-1000 MPa, alternatively 1000-1200 MPa, or alternatively 1200-1500 MPa.

Although not shown in FIG. 4, in a subsequent step, a patterned lithium storage structure may be formed on both sides including a continuous porous lithium storage layer provided by a CVD process over the respective first surfaces in accordance with embodiments similar to those shown in FIG. 1.

### Surface Layers

In some embodiments the first surface of the current collector is formed by a surface layer that is patterned in some way to form patterned lithium storage structures of the present disclosure. In some cases, the surface layer is used to provide a chemical composition at the first surface that promotes formation of an adherent continuous porous lithium storage layer, as mentioned earlier. In some embodiments, the surface layer may also be used to increase the surface roughness. In many of the subsequent figures, surface roughness differences between the first surface and second surface are not explicitly shown, but in all cases, such surface roughness differences may optionally exist using methods described above, or in some cases, the surface layer itself may contribute to some or most of the roughness. In some embodiments, at least some or most of the roughness of the first surface may be imparted by the roughness of the electrically conductive layer. In some embodiments, relative to the roughness of the underlying electrically conductive layer, the roughness of the first surface after applying the surface layer may be 5% to 10% higher, alternatively 10% to 25% higher, alternatively 25% to 50% higher, alternatively 50% to 100% higher, alternatively 100% to 150% higher, alternatively 150% to 200% higher, alternatively 200% to 500% higher, alternatively 500% to 1000% higher, alternatively 1000% to 2000% higher, or any combination of contiguous ranges thereof. In some embodiments, the nature of the roughness between the electrically conductive layer and the roughness imparted by the surface layer may be similar with respect to periodicity, magnitude, or pattern, or alternatively, it may be different. In some embodiments, the surface layer may impart an increase in roughness as measured by one type of roughness unit, e.g., measured by Rₐ, R_{q}, Rₚ, R_{z}, or P_{c}, that is greater than the increase (if any) in roughness it imparts as measured by a different roughness unit.

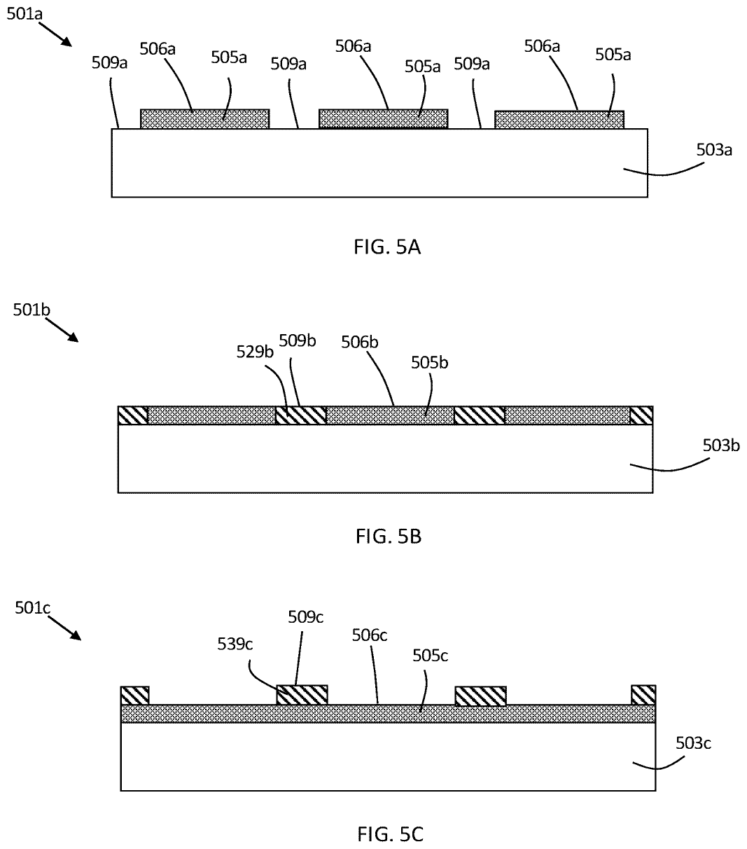

FIG. 5 shows a few non-limiting embodiments of using a surface layer to form a current collector having a first surface having different chemical composition than the second surface. FIG. 5A is a cross-sectional view illustrating a current collector 501a including electrically conductive layer 503a, a first surface 506a having a chemical composition different than second surface 509a, and surface layer 505a provided in a first pattern over the electrically conductive layer 503a. Materials and selection for use in a surface layer are discussed more below.

In some embodiments, a pattern-modifying layer may be applied in addition to the surface layer. In some embodiments, the pattern-modifying layer may be selected to form a second surface having one or more of properties (i), (ii), (iii), and (iv) described above. Alternatively, or in addition to such properties, the pattern-modifying layer may be electrically insulative to impede charge transfer from the electrically conductive layer to any overlying lithium storage material that may have been deposited on the second surface, thereby deactivating such lithium storage material from participation in electrochemical cycling. Alternatively, or in addition to such properties, the pattern-modifying layer may act as a planarizing or smoothing layer as discussed above with respect to FIG. 3. A few non-limiting examples of materials that may be useful for the pattern-modifying layer may include silicon dioxide, silicon nitride (stoichiometric), alumina, silicone polymers, fluorinated polymers, fluorinated surface modifying agents, polyimides, nickel (0), and copper (0).

For example, FIG. 5B is a cross-sectional view illustrating a current collector 501b including electrically conductive layer 503b, a first surface 506b having a chemical composition different than second surface 509b, and surface layer 505b provided in a first pattern over the electrically conductive layer 503b. The second surface 509b corresponds to the top of pattern-modifying layer 529b disposed over the electrically conductive layer 503b in a second pattern complementary to the first pattern. For clarity, only one of each feature is labeled in FIG. 5B. Although shown in approximately the same plane, the top of surface layer 505b relative to the top of the pattern-modifying layer 529b may be recessed or raised.

In some embodiments, a surface layer may be patterned by applying a pattern-modifying layer overlaying the surface layer. For example, FIG. 5C is a cross-sectional view illustrating a current collector 501c including electrically conductive layer 503c, a first surface 506c having a chemical composition different than second surface 509c. Surface layer 505c provided over the entire surface of the electrically conductive layer and a pattern-modifying layer 539c is disposed in a second pattern to form areas of uncovered surface layer corresponding to first surface 506c provided in a first pattern. The top of pattern-modifying layer corresponds to second surface 509c provided in the second pattern, complementary to the first pattern. For clarity, only one of each feature is labeled in FIG. 5C.

There are numerous suitable methods to form patterned surface layers and pattern-modifying layers, such methods depending in part on the type of material to be used and resolution. Such methods may include printing of the desired materials or their precursors, lithographic methods which may be additive or subtractive, shadow mask methods for vapor phase patterning, chemical treatments, thermal treatments, electroplating, electroless plating, atomic layer deposition, physical vapor deposition, chemical vapor deposition, plasma treatments, and others. Some non-limiting methods are described in co-pending U.S. patent application Ser. No. 16/909,008 referenced above, which may be used or modified to achieve the desired results of the present disclosure.

Although not shown in FIG. 5, in a subsequent step, a patterned lithium storage structure may be formed including a continuous porous lithium storage layer provided by a CVD process over the first surface in accordance with embodiments similar to those shown in FIG. 1.

### Multiple Surface Sublayers

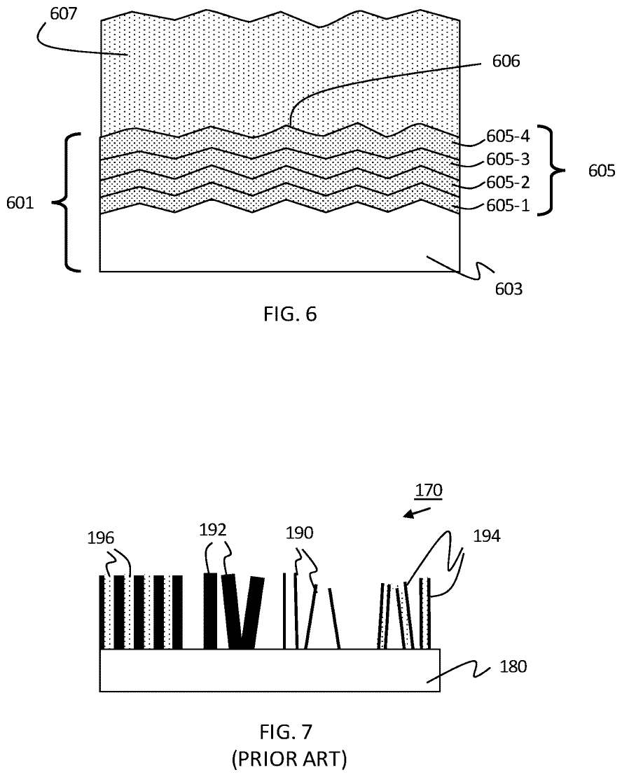

As mentioned, a surface layer may be provided over an electrically conductive layer optionally having a high surface roughness. In some embodiments, a surface layer may include two or more surface sublayers. Each sublayer of the two or more sublayers may have a composition different from the adjacent sublayer(s). The composition in each sublayer may be homogenous or inhomogenous. FIG. 6 is a cross-sectional illustration of both, zoomed in on a first surface portion only that includes the continuous porous lithium storage layer. Current collector 601 has a roughened surface 606 and includes surface layer 605 having four surface sublayers. Surface sublayer 605-1 overlays the electrically conductive layer 603. Surface sublayer 605-2 overlays surface sublayer 605-1, surface sublayer 605-3 overlays surface sublayer 605-2, and surface sublayer 605-4 overlays surface sublayer 605-3. Continuous porous lithium storage layer 607 is provided over the uppermost surface sublayer, i.e., the sublayer furthest from the electrically conductive layer 603, which in FIG. 6 is sublayer 605-4. Although shown with four surface sublayers, there may instead be two, three, five, six or more surface sublayers. Each sublayer has a different chemical composition relative to any adjacent surface sublayer, but nonadjacent surface sublayers may have the same or different chemical compositions from each other. In the description below regarding surface layers and materials, each may be considered for use as single surface layer, or alternatively as one of the surface sublayers in embodiments having two or more sublayers. In some embodiments, the multiple sublayers may have a similar surface roughness (e.g., within 5%, 10%, 15%, or 20% of the roughness of another sublayer). In some embodiments, the roughness of the multiple sublayers increases (or does not decrease) with the distance of the sublayer from electrically conductive layer 603. In other embodiments, the roughness of the multiple sublayers decreases (or does not increase) with the distance of the sublayer from electrically conductive layer 603.

### Surface Layer Materials and Properties

The materials and thickness of the surface layer may be selected so that the surface layer is, or may become, sufficiently electrically conductive (i.e., non-insulating) to allow transfer of electrical charge between the electrically conductive layer and the continuous porous lithium storage layer. In addition to the materials discussed below, the surface layer may include dopants or conductive additives such as nanowires, metal particles or the like that promote electrical conductivity. In some embodiments, the surface layer may undergo a reaction during the CVD deposition of the continuous porous lithium storage layer that causes it to become more electrically conductive. For example, the surface layer may include a metal compound and the CVD deposition process may partially reduce a metal compound to its metallic state, i.e., metal at least partly in the (0) oxidation state. In some embodiments, the surface layer material has a conductivity of at least 10² S/m, alternatively at least 10³ S/m, alternatively at least 10⁴ S/m, alternatively at least 10⁵ S/m, alternatively at least 10⁶ S/m.

The thickness of a surface layer may be as low as a monolayer in some embodiments. In some embodiments, the thickness of the surface layer is in a range of 0.0001 μm to 0.0002 μm, alternatively 0.0002 μm to 0.0005 μm, alternatively 0.0005 μm to 0.001 μm, alternatively 0.001 μm to 0.005 μm, alternatively 0.002 μm to 0.005 μm, alternatively, 0.005 μm to 0.01 μm, alternatively 0.01 μm to 0.02 μm, alternatively 0.02 μm to 0.03 μm, alternatively 0.03 μm to 0.05 μm, alternatively 0.05 μm to 0.1 μm, alternatively 0.1 μm to 0.2 μm, alternatively 0.2 μm to 0.5 μm, alternatively 0.5 μm to 1 μm, alternatively 1 μm to 2 μm, alternatively 2 μm to 5 μm or any combination of contiguous ranges thereof.

### Metals

In some embodiments the surface layer (or surface sublayer) may include metallic zinc (i.e., Zn (0)) or a zinc alloy such as Zn—Sn or Zn—Ni. In some embodiments, the surface layer may exclude bare metals (valence state of 0). In some embodiments, a surface sublayer that is not the uppermost surface sublayer may include a transition metal in its metallic (zero valent) state.

### Transition Metal Compounds

In some embodiments, the surface layer (or surface sublayer) includes a transition metal compound, e.g., a transition metal oxide, a transition metal sulfide, a transition metal hydroxide, or a transition metallate (e.g., an oxometallate such as chromate), or a mixture thereof. Unless otherwise noted, the term “transition metal” as used anywhere in the present application includes any element in groups 3 through 12 of the periodic table, including lanthanides and actinides. Note that oxometallates may be considered a subset of metal oxides where the metal oxide is anionic in nature and is associated with a cation, which may optionally be an alkali metal, an alkaline earth metal, or another transition metal. In some embodiments, the transition metal of the transition metal compound includes titanium, vanadium, chromium, manganese, iron, cobalt, nickel, copper, zinc, molybdenum, tungsten, or a mixture thereof. In some embodiments, the surface layer includes an oxide of nickel, an oxide of titanium, an oxide of chromium, chromium hydroxide, tungsten hydroxide, molybdenum hydroxide, or a chromate, or a mixture thereof. A surface layer including a transition metal compound may have homogeneous or heterogeneous distribution of elements or stoichiometries through the layer. In some embodiments, the surface layer includes some lithium oxide in addition to the transition metal compound or transition metal.

### Metal Silicide

In some embodiments the surface layer (or surface sublayer) may include a metal silicide. In some embodiments, the metal silicide layer includes a transition metal silicide. In some embodiments the metal silicide has a chemical composition characterized by MₓSi_{y}, wherein x is the combined atomic % of one or more transition metals, y is the atomic % of silicon, and the ratio of x to y is in a range of about 0.25 to about 7. The ratio of x to y may vary within a metal silicide surface layer. In some embodiments, a metal silicide surface layer has a gradient in metal content, e.g., where the atomic % of the transition metal(s) decreases in the direction towards the continuous porous lithium storage layer. In some embodiments, M=Ti, V, Cr, Mn, Fe, Co, Ni, Cu, Zr, Mo, or W, or a binary or ternary combination thereof. The metal silicide may be stoichiometric or non-stoichiometric. The metal silicide may include a mixture of metal silicides having homogeneously or heterogeneously distributed stoichiometries, mixtures of metals or both. In some embodiments, the metal silicide includes at least some nickel silicide in the form of Ni₃Si, Ni₃₁Si₁₂, Ni₂Si, Ni₃Si₂, NiSi, or NiSi₂, or a combination thereof. These particular phases may optionally be present as micro- or nano-domains within other metal silicide phases or stoichiometries present in the surface layer. In some embodiments, the metal silicide includes at least some copper silicide in the form of Cu₁₇Si₃, Cu₅₆Si₁₁, Cu₅Si, Cu₃₃Si₇, Cu₄Si, Cu₁₉Si₆, Cu₃Si, or Cu₈₇Si₁₃, or a combination thereof. These particular phases may optionally be present as micro- or nano-domains within other metal silicide phases or stoichiometries present in the surface layer. In some embodiments, the metal silicide includes at least some titanium silicide in the form of Ti₅Si₃, TiSi, TiSi₂, TiSi₃, or Ti₆Si₄, or a combination thereof. These particular phases may optionally be present as micro- or nano-domains within other metal silicide phases or stoichiometries present in the surface layer. In some embodiment, the metal silicide includes at least some chromium silicide in the form of Cr₃Si, Cr₅Si₃, CrSi, or CrSi₂, or a combination thereof. These particular phases may optionally be present as micro- or nano-domains within other metal silicide phases or stoichiometries present in the surface layer.

In addition to general patterning and deposition methods mentioned earlier for surface layer, in some embodiments, a metal silicide surface layer may be formed by heating a metal layer that is in contact with a silicon layer to cause interdiffusion and formation of the metal silicide. The necessary heating temperature depends in part on the metal. In some embodiments, the heating step includes heating to a temperature in a range of 200-300° C., alternatively 300-400° C., alternatively 400-500° C., alternatively 500-600° C., alternatively 600-700° C., alternatively 700-800° C., alternatively 800-900° C., or any combination of contiguous ranges thereof. A combination of methods may be used to form a metal silicide surface layer.

### Silicon Compound

In some embodiments, a surface layer or sublayer includes a silicon compound formed by treatment with a silane, a siloxane, or a silazane compound, any of which may be referred to herein as a silicon compound agent. In some embodiments, the silicon compound agent treatment may increase adhesion to an overlying sublayer or to the continuous porous lithium storage layer. In some embodiments, the silicon compound may be a polymer including, but not limited to, a polysiloxane. In some embodiments, a siloxane compound may have a general structure as shown in formula (1)

Si(R)ₙ(OR′)₄₋ₙ (1)
wherein, n=1, 2, or 3, and R and R′ are independently selected substituted or unsubstituted alkyl, alkenyl, or aryl groups.

The silicon compound of the surface layer or sublayer may be derived from a silicon compound agent but have a different chemical structure than the agent used to form it. In some embodiments, the silicon compound may react with the underlying surface to form a bond such as a metal-oxygen-silicon bond, and in doing so, the silicon compound may lose one or more functional groups (e.g., an OR′ group from a siloxane). In some embodiments, the silicon compound agent may include groups that polymerize to form a polymer. In some embodiments, the silicon compound agent may form a matrix of Si—O—Si cross links. In some embodiments, the PECVD deposition of a lithium storage material may alter the chemical structure of the silicon compound agent or even form a secondary derivative chemical species. The silicon compound includes silicon. The silicon compound may be the result of a silicon compound agent reacting with 1, 2, 3, or 4 reactants in 1, 2, 3, or 4 different reactions.

A silicon compound agent may be provided in a solution, e.g., at about 0.3 g/l to 15 g/l in water or an organic solvent. Adsorption methods of a silicon compound agent include an immersion method, a showering method and a spraying method and are not especially limited. In some embodiments a silicon compound agent may be provided as a vapor and adsorbed onto an underlying sublayer. In some embodiments, a silicon compound agent may deposited by initiated chemical vapor deposition (iCVD). In some embodiments, a silicon compound agent may include an olefin-functional silane, an epoxy-functional silane, an acryl-functional silane, an amino-functional silane or a mercapto-functional silane. In some embodiments, a silicon compound agent may be polymerized during deposition or after deposition. Some non-limiting examples of silicon compound agents include hexamethyldisilazane (HMDS), vinyltrimethoxysilane, vinylphenyltrimethoxysilane, 3-methacryloxypropyltrimethoxysilane, 3-glycidoxypropyltrimethoxysilane, 4-glycidylbutyltrimethoxysilane, 3-aminopropyltriethoxysilane, N-2-(aminoethyl)-3-aminopropyltrimethoxysilane, N-3-(4-(3-aminopropoxy)butoxy)propyl-3-aminopropyltrimethoxysilane, imidazolesilane, triazinesilane, 3-mercaptopropyltrimethoxysilane, 1,3,5,7-tetravinyl-1,3,5,7-tetramethylcyclotetrasiloxane, 1,3,5-trivinyl-1,3,5-trimethylcyclotrisiloxane, pentavinylpentamethylcyclopentasiloxane, and octavinyl-T8-silesquioxane. In some embodiments, a layer or sublayer including a silicon compound may include silicon, oxygen, and carbon, and may further include nitrogen or sulfur.

In some embodiments, treatment with a silicon compound agent may be followed by a step to drive off solvent or to initiate polymerization or another chemical transformation, wherein the step may involve heating, contact with a reactive reagent, or both. A surface sublayer formed from a silicon compound agent should not be so thick as to create a significant barrier to charge conduction between the current collector and the continuous porous lithium storage layer. In some embodiments, a sublayer formed from a silicon compound agent has a silicon content in a range of 0.1 to 0.2 mg/m², alternatively in a range of 0.1-0.25 mg/m², alternatively in a range of 0.25-0.5 mg/m², alternatively in a range of 0.5-1 mg/m², alternatively 1-2 mg/m², alternatively 2-5 mg/m², alternatively 5-10 mg/m², alternatively 10-20 mg/m², alternatively 20-50 mg/m², alternatively 50-100 mg/m², alternatively 100-200 mg/m², alternatively 200-300 mg/m², or any combination of ranges thereof. In some embodiments, a surface layer or sublayer formed from a silicon compound agent may include up to one monolayer of the silicon compound agent or its reaction product, alternatively up to 2 monolayers; alternatively up to 4 monolayers, alternatively up to 6 monolayers, alternatively up to 8 monolayers, alternatively up to 10 monolayers, alternatively up to 15 monolayers, alternatively up to 20 monolayers, alternatively up to 50 monolayers, alternatively up to 100 monolayers, alternatively up to 200 monolayers. The surface layer or surface sublayer having the silicon compound may be porous. In some embodiments, the silicon compound may break down or partially breaks down during deposition of the lithium storage layer.

The surface layer or surface sublayers in the first surface may include materials and methods as described in co-pending PCT Application No. PCT/US2021/039426, the entire contents of which are incorporated by reference for all purposes.

### Continuous Porous Lithium Storage Layer

In the present disclosure, the continuous porous lithium storage layer 107 is substantially free of nanostructures in the form of spaced-apart wires, pillars, tubes or the like, or in the form of ordered linear vertical channels extending through the lithium storage layer. FIG. 7 shows a cross-sectional view of a prior art anode 170 that includes some non-limiting examples of nanostructures, such as nanowires 190, nanopillars 192, nanotubes 194 and nanochannels 196 provided over a prior art current collector 180. The term “nanostructure” herein generally refers to an active material structure (for example, a structure of silicon, germanium or their alloys) having at least one cross-sectional dimension that is less than about 2,000 nm, other than a dimension approximately normal to an underlying substrate (such as a layer thickness) and excluding dimensions caused by random pores. Similarly, the terms “nanowires”, “nanopillars” and “nanotubes” refers to wires, pillars and tubes, respectively, at least a portion of which, have a diameter of less than 2,000 nm. In some embodiments, the continuous porous lithium storage layer is considered “substantially free” of nanostructures when the total area of the one or more first regions 113 has an average of fewer than 5 nanostructures per 1000 square microns (in which the number of nanostructures is the sum of the number of nanowires, nanopillars, and nanotubes in the same unit area), such nanostructures having an aspect ratio of 3:1 or higher. Alternatively, there is an average of fewer than 1 such nanostructures per 1000 square micrometers.

The continuous porous lithium storage layer includes a porous material capable of reversibly incorporating lithium. In some embodiments, the continuous porous lithium storage layer includes silicon, germanium, antimony, tin, or a mixture of two or more of these elements. In some embodiments, the continuous porous lithium storage layer is substantially amorphous. In some embodiments, the continuous porous lithium storage layer includes substantially amorphous silicon. Such substantially amorphous storage layers may include a small amount (e.g., less than 20 atomic %) of crystalline material dispersed therein. The continuous porous lithium storage layer may include dopants such as hydrogen, boron, phosphorous, sulfur, fluorine, aluminum, gallium, indium, arsenic, antimony, bismuth, nitrogen, or metallic elements. In some embodiments the continuous porous lithium storage layer may include porous substantially amorphous hydrogenated silicon (a-Si:H), having, e.g., a hydrogen content of from 0.1 to 20 atomic %, or alternatively higher. In some embodiments, the continuous porous lithium storage layer may include methylated amorphous silicon. Note that, unless referring specifically to hydrogen content, any atomic % metric used herein for a lithium storage material or layer refers to all atoms other than hydrogen.

In some embodiments, the continuous porous lithium storage layer includes at least 40 atomic % silicon, germanium or a combination thereof, alternatively at least 50 atomic %, alternatively at least 60 atomic %, alternatively at least 70 atomic %, alternatively, at least 80 atomic %, alternatively at least 90 atomic %. In some embodiments, the continuous porous lithium storage layer includes at least 40 atomic % silicon, alternatively at least 50 atomic %, alternatively at least 60 atomic %, alternatively at least 70 atomic %, alternatively, at least 80 atomic %, alternatively at least 90 atomic %, alternatively at least 95 atomic %, alternatively at least 97 atomic %. Note that in the case of prelithiated anodes as discussed below, the lithium content is excluded from this atomic % characterization.

In some embodiments, the continuous porous lithium storage layer includes less than 10 atomic % carbon, alternatively less than 5 atomic %, alternatively less than 2 atomic %, alternatively less than 1 atomic %, alternatively less than 0.5 atomic %. In some embodiments, the continuous porous lithium storage layer includes less than 1% by weight of carbon-based binders, graphitic carbon, graphene, graphene oxide, reduced graphene oxide, carbon black and conductive carbon.

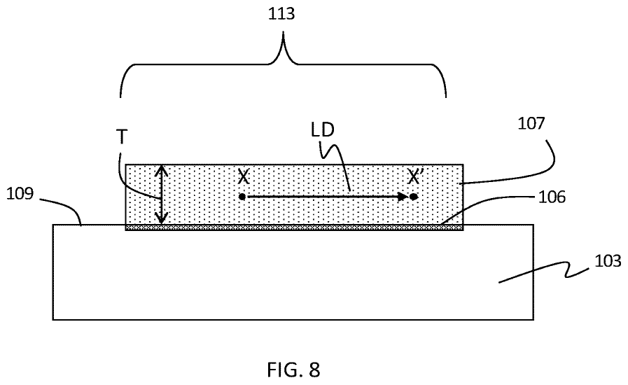

The continuous porous lithium storage layer includes voids or interstices (pores), which may be random or non-uniform with respect to size, shape, and distribution. Such porosity does not result in, or a result from, the formation of any recognizable lithium storage nanostructures such as nanowires, nanopillars, nanotubes, ordered nanochannels or the like. In some embodiments, the pores are polydisperse. In some embodiments, the continuous porous lithium storage layer may be characterized as nanoporous. In some embodiments the continuous porous lithium storage layer has an average density in a range of 1.0-1.1 g/cm³, alternatively 1.1-1.2 g/cm³, alternatively 1.2-1.3 g/cm³, alternatively 1.3-1.4 g/cm³, alternatively 1.4-1.5 g/cm³, alternatively 1.5-1.6 g/cm³, alternatively 1.6-1.7 g/cm³, alternatively 1.7-1.8 g/cm³, alternatively 1.8-1.9 g/cm³, alternatively 1.9-2.0 g/cm³, alternatively 2.0-2.1 g/cm³, alternatively 2.1-2.2 g/cm³, alternatively 2.2-2.25 g/cm³, or any combination of contiguous ranges thereof, and includes at least 80 atomic % silicon, alternatively at least 85 atomic % silicon, alternatively at least 90 atomic % silicon, alternatively at least 95 atomic % silicon. Note that a density of less than 2.3 g/cm³ is evidence of the porous nature of a-Si containing lithium storage layers. In some embodiments, the majority of active material (e.g., silicon, germanium or alloys thereof) of the continuous porous lithium storage layer has substantial lateral connectivity across portions of the current collector creating, such connectivity extending around random pores and interstices (as discussed later). Referring to FIG. 8 with reference to FIG. 1, there is shown a close up view of just one region of the continuous porous lithium storage layer shown in FIG. 1 with some additional description. In some embodiments, “substantial lateral connectivity” means that active material at one point X in the continuous porous lithium storage layer 107 may be connected to active material at a second point X′ in the layer at a straight-line lateral distance LD that is at least as great as the average thickness T of the continuous porous lithium storage layer, alternatively, a lateral distance at least 2 times as great as the thickness, alternatively, a lateral distance at least 3 times as great as the thickness. Not shown, the total path distance of material connectivity, including circumventing pores and following the topography of the current collector, may be longer than LD. In some embodiments, the continuous porous lithium storage layer may be described as a matrix of interconnected silicon, germanium or alloys thereof, with random pores and interstices embedded therein. In some embodiments, the continuous porous lithium storage layer has a sponge-like form. It should be noted that the continuous porous lithium storage layer does not necessarily extend across the entire anode without any lateral breaks and may include random discontinuities or cracks and still be considered continuous. In some embodiments, such discontinuities may occur more frequently on rough current collector surfaces. In some embodiments, the continuous porous lithium storage layer may include adjacent columns of silicon and/or nanoparticle aggregates.

In some embodiments, the continuous porous lithium storage layer includes a substoichiometric oxide of silicon (SiOₓ), germanium (GeOₓ) or tin (SnOₓ) wherein the ratio of oxygen atoms to silicon, germanium or tin atoms is less than 2:1, i.e., x<2, alternatively less than 1:1, i.e., x<1. In some embodiments, x is in a range of 0.02 to 0.95, alternatively 0.02 to 0.10, alternatively 0.10 to 0.50, or alternatively 0.50 to 0.95, alternatively 0.95 to 1.25, alternatively 1.25 to 1.50, or any combination of contiguous ranges thereof.

In some embodiments, the continuous porous lithium storage layer includes a substoichiometric nitride of silicon (SiN_{y}), germanium (GeN_{y}) or tin (SnN_{y}) wherein the ratio of nitrogen atoms to silicon, germanium or tin atoms is less than 1.25:1, i.e., y<1.25. In some embodiments, y is in a range of 0.02 to 0.95, alternatively 0.02 to 0.10, alternatively 0.10 to 0.50, or alternatively 0.50 to 0.95, alternatively 0.95 to 1.20, or any combination of contiguous ranges thereof. Lithium storage layer having a substoichiometric nitride of silicon may also be referred to as nitrogen-doped silicon or a silicon-nitrogen alloy.

In some embodiments, the continuous porous lithium storage layer includes a substoichiometric oxynitride of silicon (SiOₓN_{y}), germanium (GeOₓN_{y}), or tin (SnOₓN_{y}) wherein the ratio of total oxygen and nitrogen atoms to silicon, germanium or tin atoms is less than 1:1, i.e., (x+y)<1. In some embodiments, (x+y) is in a range of 0.02 to 0.95, alternatively 0.02 to 0.10, alternatively 0.10 to 0.50, or alternatively 0.50 to 0.95, or any combination of contiguous ranges thereof.

In some embodiments, the above sub-stoichiometric oxides, nitrides or oxynitrides are provided by a CVD process, including but not limited to, a PECVD process. The oxygen and nitrogen may be provided uniformly within the continuous porous lithium storage layer, or alternatively the oxygen or nitrogen content may be varied as a function of storage layer thickness.

### CVD

CVD generally involves flowing a precursor gas, a gasified liquid in terms of direct liquid injection CVD or gases and liquids into a chamber containing one or more objects, typically heated, to be coated. Chemical reactions may occur on and near the hot surfaces, resulting in the deposition of a thin film on the surface. This is accompanied by the production of chemical by-products that are exhausted out of the chamber along with unreacted precursor gases. As would be expected with the large variety of materials deposited and the wide range of applications, there are many variants of CVD that may be used to form the lithium storage layer, the surface layer or sublayer, a supplemental layer (see below) or other layers. It may be done in hot-wall reactors or cold-wall reactors, at sub-torr total pressures to above-atmospheric pressures, with and without carrier gases, and at temperatures typically ranging from 100-1600° C. in some embodiments. There are also a variety of enhanced CVD processes, which involve the use of plasmas, ions, photons, lasers, hot filaments, or combustion reactions to increase deposition rates and/or lower deposition temperatures. Various process conditions may be used to control the deposition, including but not limited to, temperature, precursor material, gas flow rate, pressure, substrate voltage bias (if applicable), and plasma energy (if applicable).

As mentioned, the continuous porous lithium storage layer, e.g., a layer of silicon or germanium or both, may be provided by plasma-enhanced chemical vapor deposition (PECVD). Relative to conventional CVD, deposition by PECVD can often be done at lower temperatures and higher rates, which can be advantageous for higher manufacturing throughput. In some embodiments, the PECVD is used to deposit a substantially amorphous silicon layer (optionally doped) over the surface layer. In some embodiments, PECVD is used to deposit a substantially amorphous continuous porous silicon layer over the surface layer.

### PECVD

In PECVD processes, according to various implementations, a plasma may be generated in a chamber in which the substrate is disposed or upstream of the chamber and fed into the chamber. Various types of plasmas may be used including, but not limited to, capacitively-coupled plasmas, inductively-coupled plasmas, and conductive coupled plasmas. Any appropriate plasma source may be used, including DC, AC, RF, VHF, combinatorial PECVD and microwave sources may be used. In some embodiments, magnetron assisted RF PECVD may be used.

PECVD process conditions (temperatures, pressures, precursor gases, carrier gasses, dopant gases, flow rates, energies, and the like) can vary according to the particular process and tool used, as is well known in the art.

In some implementations, the PECVD process is an expanding thermal plasma chemical vapor deposition (ETP-PECVD) process. In such a process, a plasma generating gas is passed through a direct current arc plasma generator to form a plasma, with a web or other substrate including the current collector optionally in an adjoining vacuum chamber. A silicon source gas is injected into the plasma, with radicals generated. The plasma is expanded via a diverging nozzle and injected into the vacuum chamber and toward the substrate. An example of a plasma generating gas is argon (Ar). In some embodiments, the ionized argon species in the plasma collide with silicon source molecules to form radical species of the silicon source, resulting in deposition onto the current collector. Example ranges for voltages and currents for the DC plasma source are 60 to 80 volts and 40 to 70 amperes, respectively.

Any appropriate silicon source may be used to deposit silicon, including silane (SiH₄), dichlorosilane (H₂SiCl₂), monochlorosilane (H₃SiCl), trichlorosilane (HSiCl₃), silicon tetrachloride (SiCl₄), and diethylsilane. Depending on the gas(es) used, the silicon layer may be formed by decomposition or reaction with another compound, such as by hydrogen reduction. In some embodiments, the gases may include a silicon source such as silane, a noble gas such as helium, argon, neon, or xenon, optionally one or more dopant gases, and substantially no hydrogen. In some embodiments, the gases may include argon, silane, and hydrogen, and optionally some dopant gases. In some embodiments the gas flow ratio of argon relative to the combined gas flows for silane and hydrogen is at least 3.0, alternatively at least 4.0. In some embodiments, the gas flow ratio of argon relative to the combined gas flows for silane and hydrogen is in a range of 3-5, alternatively 5-10, alternatively 10-15, alternatively 15-20, or any combination of contiguous ranges thereof. In some embodiments, the gas flow ratio of hydrogen gas to silane is in a range of 0-0.1, alternatively 0.1-0.2, alternatively 0.2-0.5, alternatively 0.5-1, alternatively 1-2, alternatively 2-5, or any combination of contiguous ranges thereof. In some embodiments, higher porosity silicon may be formed and/or the rate of silicon deposition may be increased when the gas flow ratio of silane relative to the combined gas flows of silane and hydrogen increases. In some embodiments a dopant gas is borane or phosphine, which may be optionally mixed with a carrier gas. In some embodiments, the gas flow ratio of dopant gas (e.g., borane or phosphine) to silicon source gas (e.g., silane) is in a range of 0.0001-0.0002, alternatively 0.0002-0.0005, alternatively 0.0005-0.001, alternatively 0.001-0.002, alternatively 0.002-0.005, alternatively 0.005-0.01, alternatively 0.01-0.02, alternatively 0.02-0.05, alternatively 0.05-0.10, or any combination of contiguous ranges thereof. Such gas flow ratios described above may refer to the relative gas flow, e.g., in standard cubic centimeter per minute (SCCM). In some embodiments, the PECVD deposition conditions and gases may be changed over the course of the deposition.

In some embodiments, the temperature at the current collector during at least a portion of the time of PECVD deposition is in a range of 20° C. to 50° C., 50° C. to 100° C., alternatively 100° C. to 200° C., alternatively 200° C. to 300° C., alternatively 300° C. to 400° C., alternatively 400° C. to 500° C., alternatively 500° C. to 600° C., or any combination of ranges thereof. In some embodiments, the temperature may vary during the time of PECVD deposition. For example, the temperature during early times of the PECVD may be higher than at later times. Alternatively, the temperature during later times of the PECVD may be higher than at earlier times.

The thickness or mass per unit area of the continuous porous lithium storage layer depends on the storage material, desired charge capacity and other operational and lifetime considerations. Increasing the thickness typically provides more capacity. If the continuous porous lithium storage layer becomes too thick, electrical resistance may increase and the stability may decrease. In some embodiments, the anode may be characterized as having an active silicon areal density of at least 1.0 mg/cm², alternatively at least 1.5 mg/cm², alternatively at least 3 mg/cm², alternatively at least 5 mg/cm². In some embodiments, the lithium storage structure may be characterized as having an active silicon areal density in a range of 1.5-2 mg/cm², alternatively in a range of 2-3 mg/cm², alternatively in a range of 3-5 mg/cm², alternatively in a range of 5-10 mg/cm², alternatively in a range of 10-15 mg/cm², alternatively in a range of 15-20 mg/cm², or any combination of contiguous ranges thereof “Active silicon” refers to the silicon in electrical communication with the current collector that is available for reversible lithium storage at the beginning of cell cycling, e.g., after anode “electrochemical formation” discussed later. “Areal density” refers to the surface area of the electrically conductive layer over which active silicon is provided. In some embodiments, not all of the silicon content is active silicon, i.e., some may be tied up in the form of non-active silicides or electrically isolated from the current collector.

In some embodiments the continuous porous lithium storage has an average thickness of at least 1 μm, alternatively at least 2.5 μm, alternatively at least 6.5 μm. In some embodiments, the continuous porous lithium storage layer has an average thickness in a range of about 0.5 μm to about 50 μm. In some embodiments, the continuous porous lithium storage layer comprises at least 80 atomic % amorphous silicon and/or has a thickness in a range of 1-1.5 μm, alternatively 1.5-2.0 μm, alternatively 2.0-2.5 μm, alternatively 2.5-3.0 μm, alternatively 3.0-3.5 μm, alternatively 3.5-4.0 μm, alternatively 4.0-4.5 μm, alternatively 4.5-5.0 μm, alternatively 5.0-5.5 μm, alternatively 5.5-6.0 μm, alternatively 6.0-6.5 μm, alternatively 6.5-7.0 μm, alternatively 7.0-8.0 μm, alternatively 8.0-9.0 μm, alternatively 9.0-10 μm, alternatively 10-15 μm, alternatively 15-20 μm, alternatively 20-25 μm, alternatively 25-30 μm, alternatively 30-40 μm, alternatively 40-50 μm, or any combination of ranges thereof.

In some embodiments, the second surface includes a transition metal or a transition metal layer capable of forming metal silicide structures when subjected to a vaporized silicon source and elevated temperatures. In some embodiments, the second surface includes nickel and PECVD silicon deposition conditions are selected to form nickel silicide structures such as nanowires or microwires in the second pattern, for example, by subjecting the nickel-containing electrically conductive layer to a temperature in a range of 450-550° C. As discussed below, the continuous porous lithium storage layer of silicon may concurrently deposit over the first surface in the first pattern along with the metal silicide structures over the second surface in the second pattern. However, to avoid substantial growth of such metal silicide structures in the second pattern, the temperature may be lower, for example, to a range of 150 to 375° C., sufficient to deposit the silicon of the continuous porous lithium storage layer.

### Removal of Lithium Storage Material on Second Surface

In some embodiments, after deposition of the continuous porous lithium storage layer, there may optionally be a cleaning step to remove unwanted material that may have been deposited on the second surface. Such cleaning may include sonication, contact with a brush or wipe, contact with a fluid jet (liquid or gas), flexure of the anode, or transfer to a delamination substrate that may include an adhesion layer (e.g., adhesive tape).

### Patterns

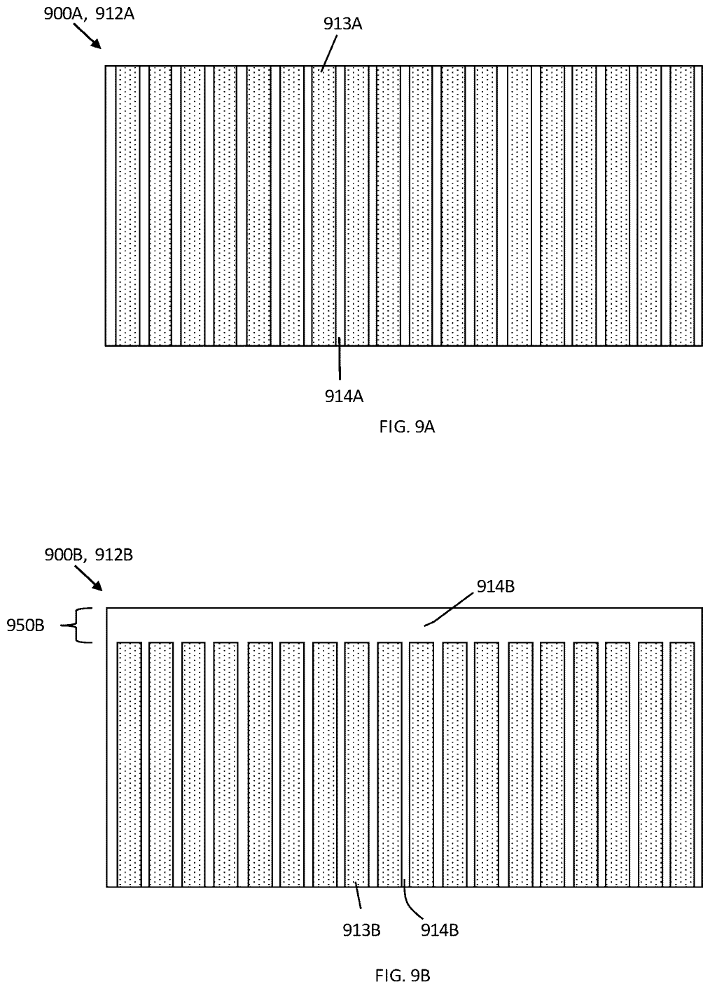

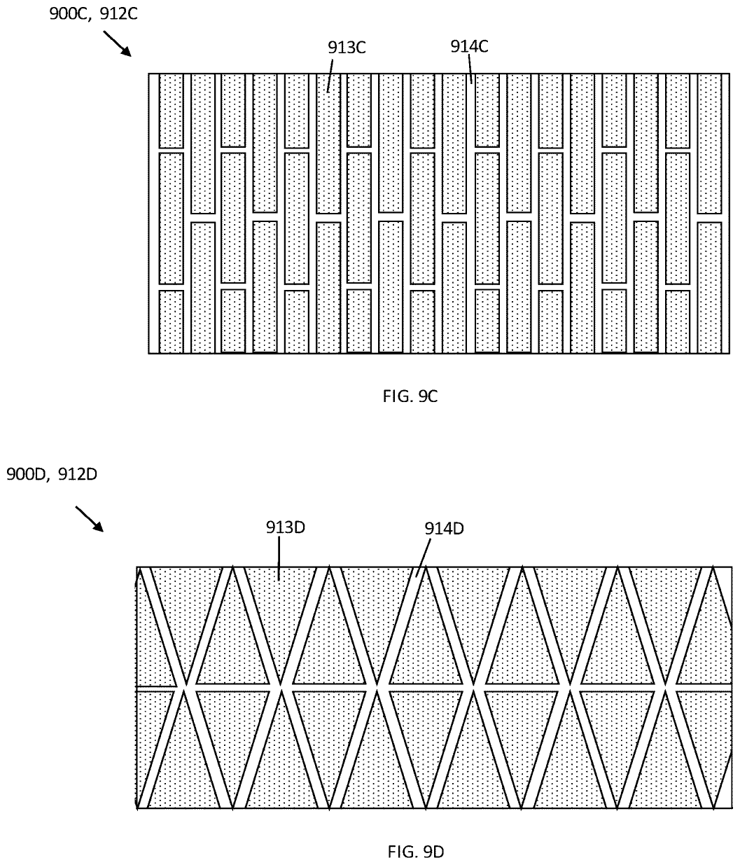

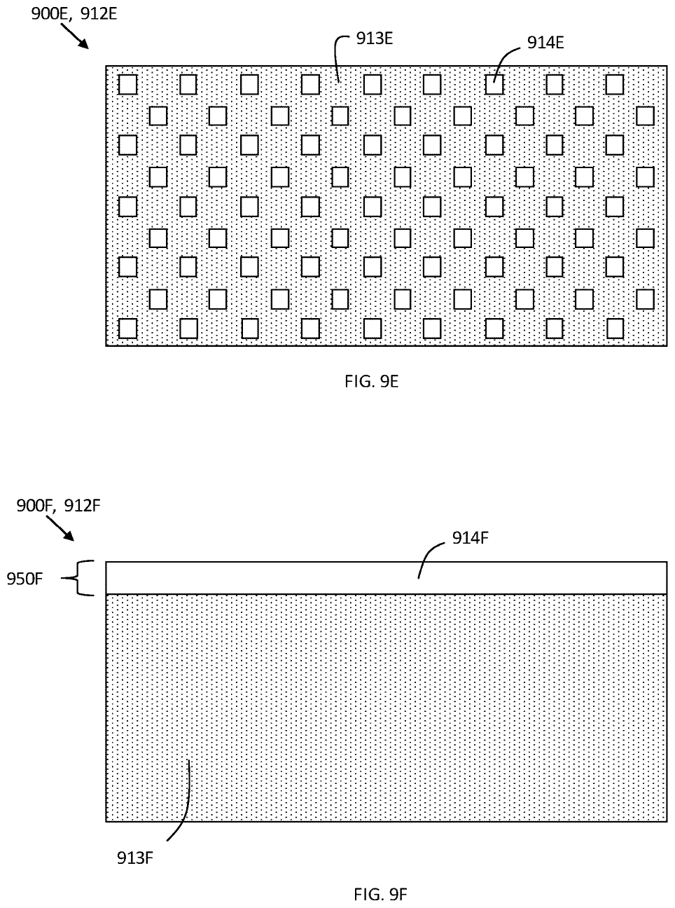

According to various embodiments of the present disclosure, the one or more first regions of the continuous porous lithium storage layer may readily be provided in almost any pattern desired, enabling a multitude of potential functionalities. FIGS. 9A-9G are plan views of anodes 900A-900G having variously patterned lithium storage structures 912A-912G. Each includes one or more first regions 913A-913G having a continuous porous lithium storage layer including a first lithium storage material overlaying the first surface (not visible in the plan view) and further including one or more second regions 914A-914G, in these embodiments substantially free of the continuous porous first lithium storage layer. Note that the term “patterned lithium storage structure” generally refers to the apparent 2D pattern of the lithium storage material formed over the current collector, for example, as shown in plan views of FIGS. 9A-9G.

In FIG. 9A, anode 900A includes patterned lithium storage structure 912A having one or more first regions 913A patterned as stripe features extending from about one end of the current collector to the other and separated by one or more second regions 914A. In some embodiments, the anode may be wound into a jelly roll energy storage device along with a cathode and one or more separators. The stripe features may be provided in a direction parallel to the axis of winding. In this way, the potential stress on the lithium storage layer caused by bending during winding is reduced and controlled. Without the pattern, the lithium storage layer may randomly crack and delaminate during winding.

In FIG. 9B, anode 900B includes patterned lithium storage structure 912B having one or more first regions 913B patterned as stripe features similar to FIG. 9A, but a contact tab region 950B is also provided as part of the one or more second regions 914B. In some embodiments the contact tab region 950B is substantially free of lithium storage material, thereby enabling easy contact of the electrically conductive layer to an anode terminal, with reduced or no need to etch, rub or clean off the area.

In FIG. 9C, anode 900C includes patterned lithium storage structure 912C having one or more first regions 913C patterned as rectangular islands separated by one or more second regions 914C.

In FIG. 9D, anode 900D includes patterned lithium storage structure 912D having one or more first regions 913D patterned as triangular islands separated by one or more second regions 914D.

In FIG. 9E, anode 900E includes patterned lithium storage structure 912E having one or more first regions 913E patterned with openings corresponding to one or more second regions 914E.

In FIG. 9F, anode 900F includes patterned lithium storage structure 912F having one or more first regions 913F and one or more second regions 914F in the form of contact pad region 950F.

In FIG. 9G, anode 900G includes patterned lithium storage structure 912G having one or more first regions 913G having a random pattern with a variety of shapes separated by one or more second regions 914G.

It should be noted that both sides of the current collector may optionally include a patterned lithium storage structure, and the two sides may have the same or a different pattern, e.g., to account for differences in stresses when winding. In some embodiments, one side of the current collector includes a patterned lithium storage structure and the other side includes a non-patterned lithium storage layer.

Patterning resolution, i.e., the minimum practical lateral dimension or feature width of the first or second region, may be a function of patterning method, a surface layer thickness and target lithium storage layer thickness. In some embodiments, the feature width is at least 1 μm, alternatively at least 2 μm, alternatively at least 5 μm, alternatively at least 10 μm. In some embodiments, the feature width is in a range of 1 μm-2 μm, alternatively 2 μm-5 μm, alternatively 5 μm-10 μm, alternatively 10 μm-20 μm, alternatively 20-50 μm, alternatively 50 μm-100 μm, alternatively 100 μm to 200 μm, alternatively 200-500 μm, alternatively 500 μm-1 mm, alternatively 1 mm-2 mm, alternatively 2 mm-5 mm, alternatively 5 mm to 10 mm, or any combination of ranges thereof.

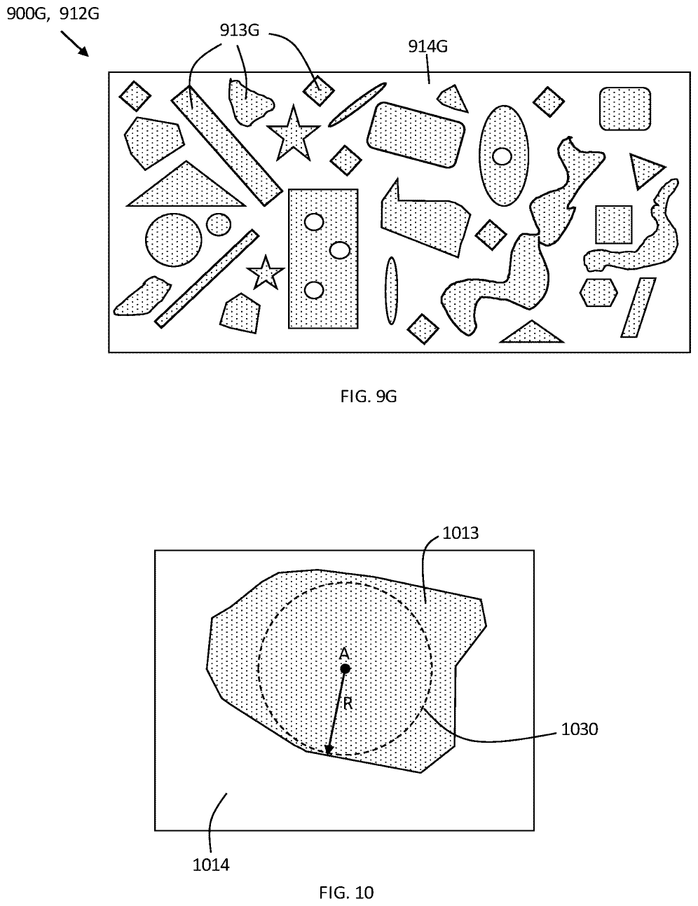

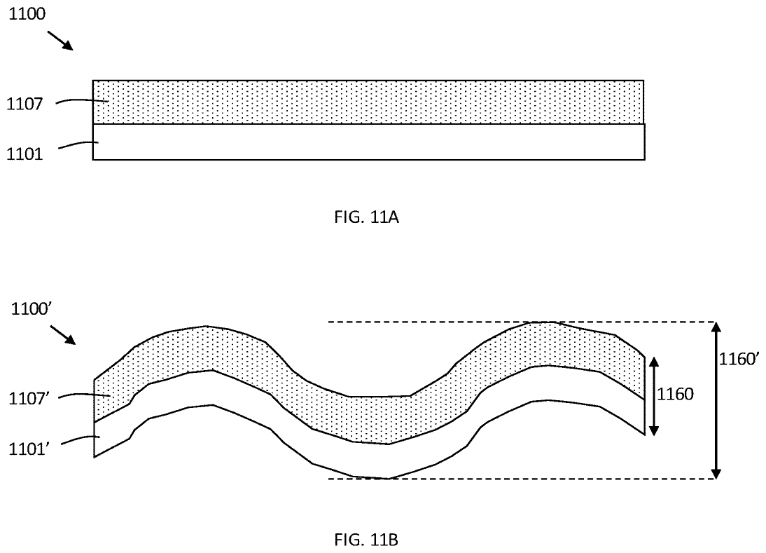

In some embodiments the patterned lithium storage structure includes one or more first regions characterized by a critical dimension which represents the maximum radial distance between any point within the first region to a second region not having the continuous porous lithium storage layer of the first region. FIG. 10 illustrates an example of a radial distance R measurement about imaginary circle 1030 from point A within a first region 1013 to second region 1014. In some embodiments, the critical distance is less than 2 mm, alternatively less than 1 mm, alternatively less than 500 μm, alternatively less than 250 μm, alternatively less than 100 μm, alternatively less than 50 μm, alternatively less than 25 μm. In some embodiments, the average critical distance for the one or more first regions is in a range of 10 μm to 25 μm, alternatively 25 μm to 50 μm, alternatively 50 μm to 100 μm, alternatively 100 μm to 250 μm, alternatively 250 μm to 500 μm, alternatively 500 μm to 1 mm, alternatively 1 mm to 2 mm, alternatively 2 mm to 5 mm, or any combination of contiguous ranges thereof.

In some embodiments, the one or more first regions (e.g., 113 in FIG. 1) include substantially all of the anode's active lithium storage material in the form of the continuous porous lithium storage layer over the first surface. Depending on the total capacity requirement of the battery, the total area of first region(s) (e.g., 113) relative to the total area of the second region(s) (e.g., 114) may be at least 1:2, alternatively at least 1:1, alternatively at least 2:1, alternatively at least 3:1, alternatively at least 4:1, alternatively at least 5:1, alternatively at least 7:1, alternatively at least 10:1; alternatively at least 15:1, alternatively at least 20:1, alternatively at least 50:1. Higher ratios may allow for increased charge capacity per unit area.

### Anode Deformations

As mentioned, the one or more second regions (e.g., 114) or the second pattern (e.g., 109) may in some cases provide areas of stress relief when bending or winding the anode and/or contact areas for making electrical connection to the battery cell. In some cases, it has been found that when the first surface forms a strong bond with a continuous porous lithium storage layer and there are no second regions, large stresses are placed on the electrically conductor during electrochemical cycling of the anode. This may lead to deformations and buckling of the current collector and anode. Although the anode may still be functional, such deformations and buckling may in some cases cause unacceptable geometrical changes to the battery, e.g., an apparent increase in thickness. Most of this expansion is not due to silicon itself, but to the deformations caused in the anode overall including the current collector. A cross-sectional view of such buckling is shown in FIG. 11. In FIG. 11A, there is an anode 1100 prior to electrochemical cycling and includes a non-patterned continuous porous lithium storage layer 1107 adherently formed over current collector 1101, e.g., using a surface layer or roughening method discussed previously (not shown here). After cycling, as shown in FIG. 11B, the anode 1100′ has significantly deformed and buckled including the current collector 1101′ and continuous porous lithium storage layer 1107′. With electrochemical cycling, the continuous porous lithium storage structure, particularly if based largely on amorphous silicon, expands and contracts during lithiation and delithiation. Some of the expansion of the continuous porous lithium storage layer during lithiation occurs in a direction normal to the current collector, but such expansion also imparts some lateral forces in plane with the current collector. Some of these lateral forces may be relieved by stretching or bending of the current collector. Upon delithiation, the stresses on the current collector may be reversed resulting in additional deformations. The cycled anode may have an actual thickness of 1160, but the apparent thickness 1160′, e.g., as might be measured in a battery cell, is much higher.

By patterning the anode according to some embodiments of the present disclosure, the stresses applied to the current collector may be substantially reduced thereby lessening physical deformations and buckling. As such, the apparent thickness after cycling may be made closer to the actual thickness.

In some embodiments, the pattern is chosen to induce a controlled deformation that may be managed. That is, without a patterned lithium storage structure, the anode deformations may be mostly random in nature. However, by applying a pattern, some deformations may still occur, but their shapes can in part be predetermined by the first pattern. In this way, the rest of the cell components may be appropriately adjusted in advance to account for the change in shape.

In some embodiments, the current collector may have high tensile strength and be more resistant to deformations during cycling. In such cases, the stresses caused by cycling of a non-patterned continuous porous lithium storage layer cannot be transferred to the current collector and may instead cause catastrophic delamination of the continuous porous lithium storage layer. By patterning an anode having a high tensile strength current collector according to some embodiments of the present disclosure, the stresses of electrochemical cycling may be substantially reduced and result in an anode that undergoes low buckling with a continuous porous lithium storage layer that remains adhered.

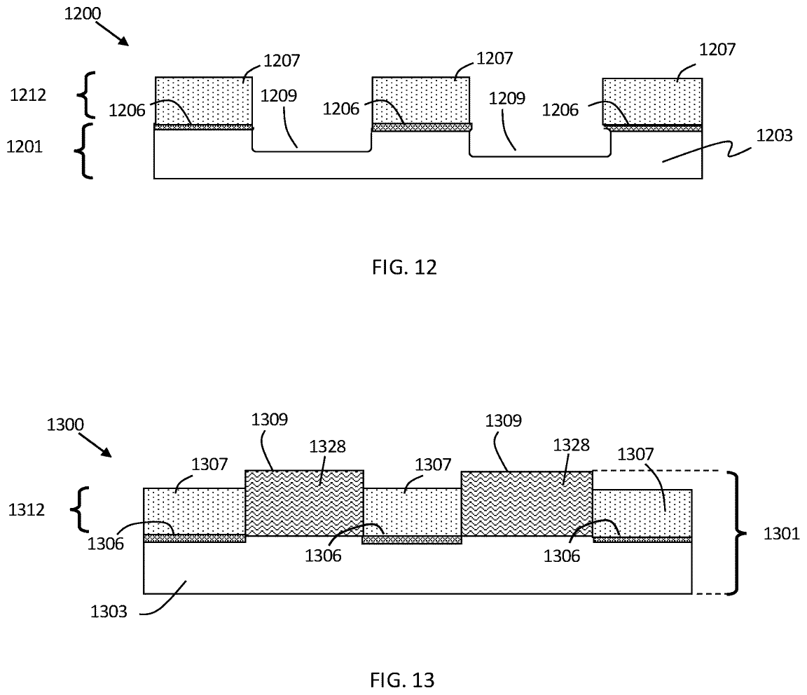

In some embodiments, the second surfaces and second regions primarily provide space to allow for more robust handling of the anode or for the continuous porous lithium storage layer to expand, as described above. However, in some embodiments, the second regions may be designed to provide additional functionality or benefits to the anode. In some embodiments, the second surface may be recessed relative to the first surface. For example, FIG. 12 is a cross-sectional view of anode 1200 having patterned lithium storage structure 1212 including continuous porous lithium storage layer 1207 disposed over first surface 1206 of current collector 1201 including electrically conductive layer 1203. The second surface 1209 of the current collector is recessed relative to the first surface. The recessed portion may allow for additional flexibility of the current collector and/or additional volume for expansion or other lithium storage materials, nanowires or functional compositions as discussed below. The properties of the second surface may also be selected to have one or more of properties (i), (ii), (iii), and (iv) described above.

In some other embodiments, the first surface of the current collector may be recessed relative to the second surface. For example, FIG. 13 shows anode 1300 having patterned lithium storage structure 1312 including continuous porous lithium storage layer 1307 disposed over first surface 1306 of current collector 1301 including electrically conductive layer 1303. Current collector 1301 further includes raised structures 1328 that form second surface 1309. In some embodiments, the raised structures may include a metal provided, for example, by electroless plating or electroplating. Such raised structures may act as lateral expansion confinement barriers to limit lateral swell of the continuous porous lithium storage layer 1307. The raised structures may increase the effective tensile strength of the current collector. If made of a metal or other conductive material, the raised metal structures may also act to improve electrical connectivity to the continuous porous lithium storage layer 1307. In some embodiments, the raised structure has a height (the vertical distance between the first surface and second surface), that is at least 10% of the thickness of the continuous porous lithium storage layer, alternatively at least 20%, alternatively at least 50%. The properties of the second surface may also be selected to have one or more of properties (i), (ii), (iii), and (iv) described above.

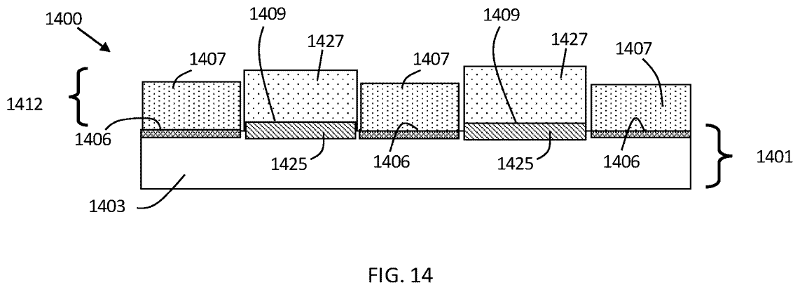

In some embodiments, the second surface may include a compliant material that allows for moderately adherent deposition of a second lithium storage material, but that may flex during electrochemical cycling. For example, FIG. 14 shows anode 1400 having patterned lithium storage structure 1412 including a first continuous porous lithium storage layer 1407 disposed in first regions over first surface 1406 of current collector 1401 including electrically conductive layer 1403. Current collector 1401 further includes a compliant material layer 1425 disposed over the electrically conductive layer in a second pattern and that forms second surface 1409. The patterned lithium storage structure further includes a second continuous porous lithium storage layer 1427 disposed in second regions over the second surface 1409. In some embodiments, the compliant material layer 1425 includes an oxide of nickel or an oxide of titanium, and the first surface includes one or more features described above, but does not include an oxide of nickel or an oxide of titanium. In some cases, it has been found that nickel oxides or titanium oxides may, upon electrochemical cycling, form a soft but electrically conductive interface with the overlying second continuous porous lithium storage layer. After cycling, the second continuous porous lithium storage layer may partially break apart, but mostly maintains contact with the compliant layer. Despite that the second regions are not open spaces in the present embodiment, such restructuring ability of the second lithium storage layer in the second regions may allow the stresses on the current collector caused by electrochemical cycling of the first continuous porous lithium storage layer to be reduced.

In some embodiments of the present disclosure, anodes of the present disclosure may include a second lithium storage material overlaying at least a portion of the second surface in second regions, wherein either or both the chemical composition or physical structure of the second lithium storage material are different than the continuous porous lithium storage layer.

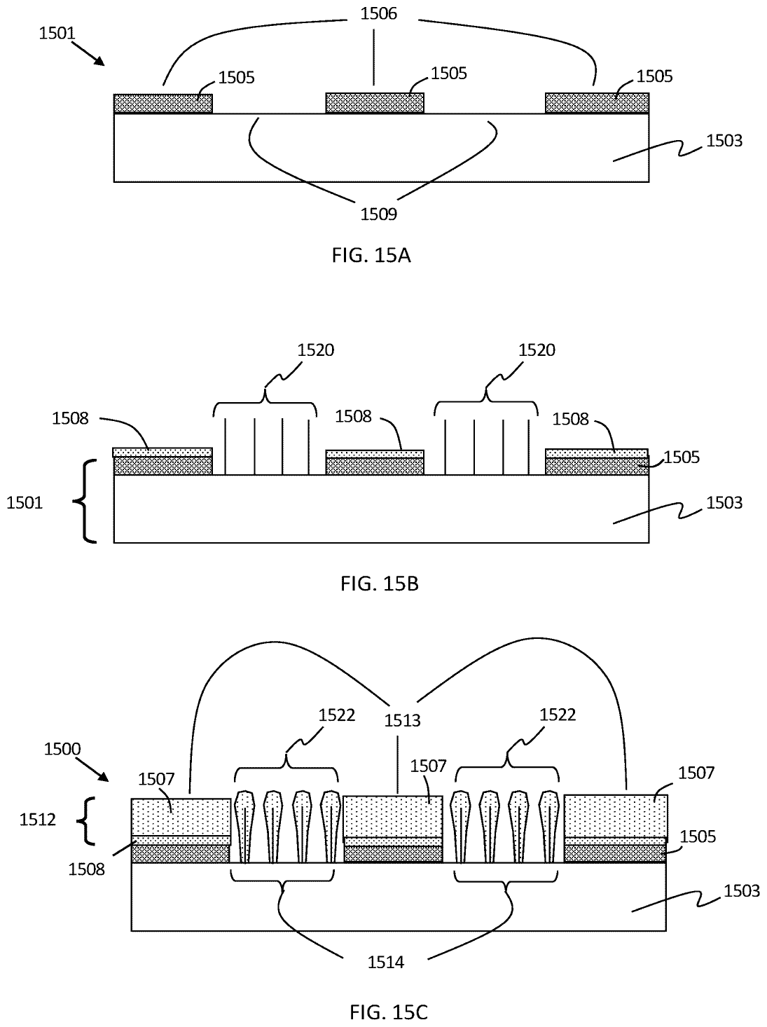

In some embodiments, the second regions may include a plurality of lithium storage structures such as nanostructures, e.g., nanowires, formed on the current collector over the second surface. Methods of growing lithium storage nanowires are well known in the art, including but not limited to CVD and PECVD methods described in U.S. Pat. Nos. 9,325,014 and 8,257,866, the entire contents of which are incorporated by reference for all purposes. FIGS. 15A-15C show a method for forming a patterned lithium storage structure according to some embodiments of the present disclosure. In FIG. 15A, a current collector 1501 includes electrically conductive layer 1503, surface layer 1505 corresponding to first surface 1506 provided in a first pattern over the electrically conductive layer, and second surface 1509 provided in a second pattern complementary to the first. The surface layer 1505 may include a transition metal compound, for example, a transition metal oxide. The electrically conductive layer or at least the second surface 1509 may include metallic nickel (i.e., nickel (0)) or a nanowire catalyst material. Heating the current collector, e.g., 450-550° C. in the presence of an appropriate precursor gas (e.g. silane) may cause catalyzed growth of alloyed nanowires 1520, e.g., nickel silicide alloy nanowires, over the second surface 1509 but not over the surface layer 1505, as shown in FIG. 15B. Instead of silane, germane or some other appropriate precursor gas may be used to form the alloyed nanowires. In some embodiments, some silicon, germanium or other material of the precursor gas may also deposit as a non-nanostructured layer 1508 over the patterned transition metal compound layer during the growth of the alloyed nanowires. The non-nanostructured layer 1508 may also function as a lithium storage layer. In some embodiments, the non-nanostructured layer 1508 may be a continuous porous lithium storage layer. In some embodiments as shown in FIG. 15C, after growth of alloyed nanowires, the vapor deposition conditions (temperature, precursor gas, flow rates, pressure, or other conditions) may be altered to lessen or stop alloyed nanowire formation and allow deposition of a lithium storage material (e.g. amorphous silicon) over both the one or more first regions 1513 to form of continuous porous lithium storage layer 1507 and over the alloyed nanowire structures of the second regions 1514 (e.g., in the form of lithium storage nanowires 1522). That is, in some embodiments, the patterned lithium storage structure 1512 includes one or more first regions of the continuous porous lithium storage layer 1507 (and optionally non-nanostructured layer 1508) and one or more second regions 1514 including lithium storage nanowires 1522). In some embodiments, the lithium storage material includes silicon, germanium or both. In some embodiments, the growth of alloyed nanowires is self-limiting, e.g., by limiting the amount nickel. In some embodiments, formation of the continuous porous lithium storage layer and lithium storage nanowires is performed in a common step and/or without breaking low pressure conditions of the vapor deposition chamber. In some embodiments, the alloyed nanowires are grown by CVD and the lithium storage material of the first and second regions is deposited by PECVD. In some embodiments, PECVD is used to grow the alloyed nanowires and deposit the lithium storage material of the first and second regions.

In some embodiments (not shown), most of the continuous porous lithium storage layer 1507 is deposited under a first set of conditions and then followed by a change in conditions to form alloyed nanowires, and optionally lithium storage nanowires, in the second region.

Prior art lithium storage nanowires may have certain disadvantages, one of which is physical robustness to handling (e.g. rubbing) causing nanowires to break off. On the other hand, nanowire structures may be more robust to bending stresses induced during winding than continuous layers of lithium storage material. According to some embodiments of the present disclosure, the first regions may help physically protect the nanowires in the second regions. By providing lithium storage nanowires in the one or more second region, the loss in surface area capacity caused by patterning the continuous porous lithium storage layer can be partially or entirely recovered. Further, the combination of two types of lithium storage structures may provide the anode with a broader range of charging and discharging capabilities and/or increased lifetime. In addition, the plurality of lithium storage structures such as nanowires have been found not to apply lower stresses to the current collector resulting in less anode deformation.

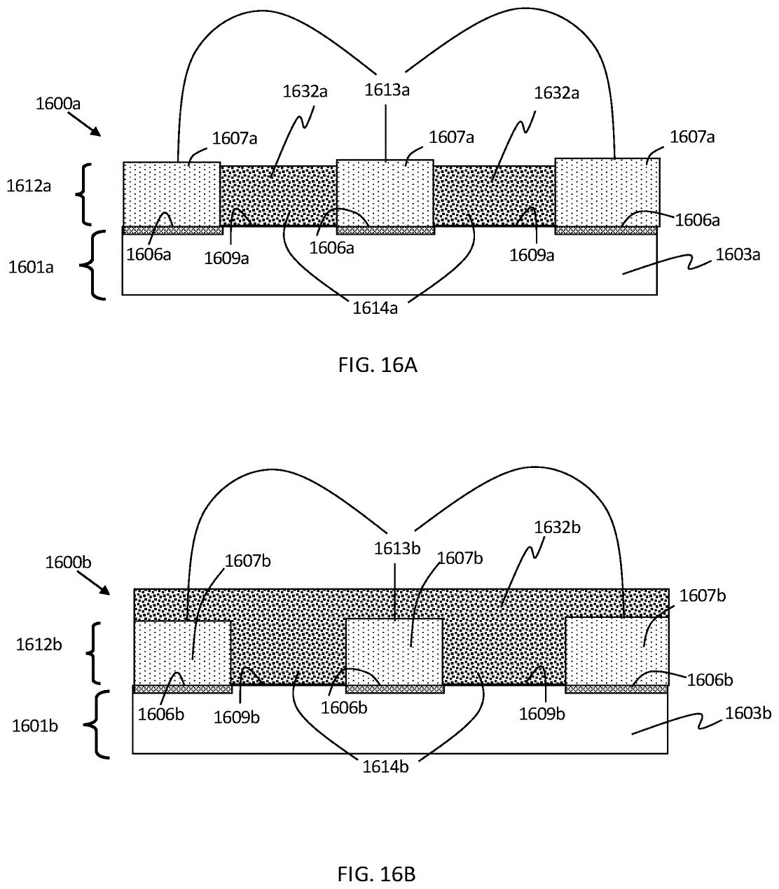

In some embodiments, the patterned lithium storage structure includes a functional composition in second regions deposited over the second surface. As shown in FIG. 16A and FIG. 16B, an anode (1600a, 1600b) includes a patterned lithium storage structure (1612a, 1612b) including one or more first regions (1613a, 1613b) having a continuous porous lithium storage layer (1607a, 1607b) overlaying a first surface (1606a, 1606b) of current collector (1601a, 1601b), the first surface having a first pattern. The current collector further includes electrically conductive layer (1603a, 1603b) and second surface (1609a, 1609b) having a second pattern complementary to the first. In FIG. 16A, anode 1600a further includes functional composition 1632a deposited over second surface 1609a in one or more second regions 1614a. FIG. 16B is similar except that functional composition 1632b is deposited over second surface 1609b in the one or more second regions 1614b and also over continuous porous lithium storage layer 1607b.

In some embodiments the functional composition may be deposited by wet coating or printing method, including but not limited to, screen printing, inkjet printing, gravure printing, offset printing, flexographic printing, curtain coating, spray coating, spin coating and slot die coating. For example, the functional composition may be coated over the entire anode and substantially removed from the top surface of the continuous porous lithium storage layer 1607a by a doctor blade or squeegee (FIG. 16A). In some embodiments, the functional material may be pattern-printed into the one or more second regions 1614a (FIG. 16A). In some embodiments, the functional composition is deposited and remains over both the second pattern and the continuous porous lithium storage layer 1607a (FIG. 16B).

In some embodiments, the functional composition may act as a supplemental active lithium storage layer for the anode and may be provided, for example, by coating a slurry containing an active lithium storage material (e.g., graphite or silicon-containing particles), a binder matrix and a solvent. Many other coatable, binder-based lithium storage layers are known in the art and may be used. Such binder-based lithium storage layers generally have lower areal lithium storage capacity than the continuous porous lithium storage layer. However, some may more easily withstand bending stresses during winding or the like and will at least partially offset the loss in surface area capacity caused by patterning the continuous porous lithium storage layer.

In some embodiments where the one or more second regions include active lithium storage materials, e.g., as lithium storage nanowires, a binder-based lithium storage material or the like, the ratio of the total area of first region(s) of continuous porous lithium storage layer (e.g., 1513, 1613a, 1613b) relative to the total area of the second region(s) (e.g., 1514, 1614a, 1614b) may be in range of 50:1 to 20:1, alternatively 20:1 to 10:1, alternatively 10:1 to 5:1, alternatively 5:1 to 2:1, alternatively 2:1 to 1:1, alternatively 1:1 to 1:2, alternatively 1:2 to 1:5, alternatively 1:5 to 1:10, alternatively 1:10 to 1:20, alternatively 1:20 to 1:50, or any combination of contiguous ranges thereof.

In some embodiments, the functional composition includes a polymer comprising a source of lithium ion, e.g., as lithium sulfonate or lithium carboxylate groups or the like. This may be used to supplement the lithium ion present in the electrolyte and reduce possible lithium ion starvation effects due to irreversible losses of lithium in the anode over time.

In some embodiments, the functional composition may act to partially confine expansion of the continuous porous lithium storage layer (1607a, 1607b) that may occur during lithiation. Such confinement may help increase lifetime. In some embodiments, the expansion confinement composition may include a polymer or a mixture of a polymer and inorganic particles. In some embodiments, the expansion confinement primarily directed to a lateral expansion (as in FIG. 16A). In some embodiments where the functional composition also overcoats the continuous porous lithium storage layer, the expansion confinement may act on the entire continuous porous lithium storage layer (1607a, 1607b) as in FIG. 16B. In some embodiments the functional composition includes a material that strongly binds to the second surface thereby creating a strong anchor to hold the continuous porous lithium storage layer (1607a, 1607b) in place. In some embodiments the confining functional composition has some stretchability (e.g., it may include a stretchable polymer such as a polysiloxane) to allow limited expansion of the continuous porous lithium storage layer.

In some embodiments, the functional composition (1632a, 1632b) may include an electrically conductive material, e.g., silver (or other metal) nanowires, metallic particles, a conductive polymer, a conductive metal oxide, carbon nanofibers, carbon nanotubes, or a combination. In some embodiments, the presence of such electrically conductive materials may help enable electrical continuity of the anode after electrochemical cycling and some possible breakdown of the continuous porous lithium storage layer structure. In some embodiments the functional composition may include an electrically conductive material mentioned above, but the conductive materials are sufficiently dilute in a binder or matrix so that the functional composition itself does not readily conduct electrical current at normal battery operating voltages.

In some embodiments, functional composition (1632a, 1632b) may be conductive to lithium ions. In the case where the functional composition 1632b is over continuous porous lithium storage layer 1607b (FIG. 16B), the functional composition should generally have some lithium ion conductivity, e.g., is at least 10⁻⁹ S/cm, alternatively at least 10⁻⁸ S/cm, alternatively at least 10⁻⁷ S/cm, alternatively at least 10⁻⁶ S/cm.

In some embodiments, the functional composition may act as a solid-state electrolyte or separator.

In some embodiments, the functional composition may include any combination of materials or functions described above.

In some embodiments, the second region may include lithium storage nanowires grown on the current collector and one or more functional composition according to any of the embodiments described above.

Although not shown, in some embodiments, the second continuous porous lithium storage layer, the plurality of second lithium storage structures, or the functional material may be provided over the second surface in a third pattern that constitutes a subset of the second pattern, but spaced away from the first pattern, thereby leaving some open space adjacent to the first regions.

### Other Features

The anode may optionally include various additional layers and features. The current collector may include one or more features to ensure that a reliable electrical connection can be made in the energy storage device. In some embodiments, a supplemental layer is provided over the patterned lithium storage structure. In some embodiments, the supplemental layer is a protection layer to enhance lifetime or physical durability. The supplemental layer may be an oxide formed from the lithium storage material itself, e.g., silicon dioxide in the case of silicon, or some other suitable material. A supplemental layer may be deposited, for example, by ALD, CVD, PECVD, evaporation, sputtering, solution coating, ink jet or any method that is compatible with the anode. In some embodiments the supplemental layer may conformally coat the patterned lithium storage structure. In some embodiments, the top surface of the supplemental layer corresponds to a top surface of the anode.

A supplemental layer should be reasonably conductive to lithium ions and permit lithium ions to move into and out of the patterned lithium storage structure during charging and discharging. In some embodiments, the lithium ion conductivity of a supplemental layer is at least 10⁻⁹ S/cm, alternatively at least 10⁻⁸ S/cm, alternatively at least 10⁻⁷ S/cm, alternatively at least 10⁻⁶ S/cm. In some embodiments, the supplemental layer acts as a solid-state electrolyte.

Some non-limiting examples of materials used in a supplemental layer include metal oxides, nitrides, or oxynitrides, e.g., those containing aluminum, titanium, vanadium, zirconium or tin, or mixtures thereof. The metal oxide, metal nitride or metal oxynitride may include other components such as phosphorous or silicon. The supplemental layer may include a lithium-containing material such as lithium phosphorous oxynitride (LIPON), lithium phosphate, lithium aluminum oxide, (Li,La)ₓTi_{y}O_{z}, or LiₓSi_{y}Al₂O₃. In some embodiments, the supplemental layer includes a metal oxide, metal nitride, or metal oxynitride, and has an average thickness of less than about 100 nm, for example, in a range of about 0.1 to about 10 nm, or alternatively in a range of about 0.2 nm to about 5 nm. UPON or other solid-state electrolyte materials having superior lithium transport properties may have a thickness of more than 100 nm, but may alternatively, be in a range of about 1 to about 50 nm.

In some embodiments, the continuous porous lithium storage layer may be at least partially prelithiated prior to a first electrochemical cycle after battery assembly, or alternatively prior to battery assembly. That is, some lithium may be incorporated into the continuous porous lithium storage layer to form a lithiated storage layer even prior to a first battery cycle. In some embodiments, the lithiated storage layer may break into smaller structures, including but not limited to platelets, that remain electrochemically active and continue to reversibly store lithium. Note that “lithiated storage layer” simply means that at least some of the potential storage capacity of the lithium storage layer is filled, but not necessarily all. In some embodiments, the lithiated storage layer may include lithium in a range of 1% to 5% of the theoretical lithium storage capacity of the continuous porous lithium storage layer, alternatively 5% to 10%, alternatively 10% to 15%, alternatively 15% to 20%, alternatively, 20% to 30%, alternatively 30% to 40%, alternatively 40% to 50%, alternatively 50% to 60%, alternatively 60% to 70%, alternatively 70% to 80%, alternatively 80% to 90%, alternatively 90% to 100%, or any combination of ranges thereof. In some embodiments, a surface layer may capture some of the lithium, and one may need to account for such capture to achieve the desired lithium range in the lithiated storage layer.

In some embodiments prelithiation may include depositing lithium metal over the continuous porous lithium storage layer, alternatively between one or more lithium storage sublayers, or both, e.g., by evaporation, e-beam or sputtering. Alternatively, prelithiation may include contacting the anode with a reductive lithium organic compound, e.g., lithium naphthalene, n-butyllithium or the like. In some embodiments, prelithiation may include incorporating lithium by electrochemical reduction of lithium ion in prelithiation solution. In some embodiments, prelithiation may include a thermal treatment to aid the diffusion of lithium into the lithium storage layer.

In some embodiments the anode may be thermally treated prior to battery assembly. In some embodiments, thermally treating the anode may improve adhesion of the various layers or electrical conductivity, e.g., by inducing migration of metal from the current collector or atoms from the optional supplemental layer into the continuous porous lithium storage layer. In some embodiments, the continuous porous lithium storage layer includes at least 80 atomic % amorphous silicon and at least 0.05 atomic % copper, alternatively at least 0.1 atomic % copper, alternatively at least 0.2 atomic % copper, alternatively at least 0.5 atomic % copper, alternatively at least 1 atomic % copper. In some embodiments, the continuous porous lithium storage layer may include at least 80 atomic % amorphous silicon and also include copper in an atomic % range of 0.05-0.1%, alternatively 0.1-0.2%, alternatively 0.2-0.5%, alternatively 0.5-1%, alternatively 1-2%, alternatively 2-3%, alternatively 3-5%, alternatively 5-7%, or any contiguous combination of ranges thereof. In some embodiments, the aforementioned ranges of atomic % copper may correspond to a cross-sectional area of the continuous porous lithium storage layer of at least 1 μm², which may be measured, e.g., by energy dispersive x-ray spectroscopy (EDS). In some embodiments, there is a gradient where the concentration of copper in portions of the continuous porous lithium storage layer near the current collector is higher than portions further from the current collector. In some embodiments, instead of copper or in addition to copper, the continuous porous lithium storage layer may include another transition metal such as zinc, chromium or titanium, e.g., when the surface layer includes a metal oxide layer of TiO₂. The atomic % of such transition metals (Zn, Cr, or Ti) may be present in the continuous porous lithium storage layer in any of the atomic % ranges mentioned above with respect to copper. In some embodiments, the continuous porous lithium storage layer may include more copper than other transition metals. Special thermal treatments are not always necessary to achieve migration of transition metals into the lithium storage layer.

In some embodiments, thermally treating the anode may be done in a controlled environment having a low oxygen and water (e.g., less than 10 ppm or partial pressure of less than 0.1 Torr, alternatively less than 0.01 Torr content to prevent degradation). In some embodiments, anode thermal treatment may be carried out using an oven, infrared heating elements, contact with a hot plate or exposure to a flash lamp. The anode thermal treatment temperature and time depend on the materials of the anode. In some embodiments, anode thermal treatment includes heating the anode to a temperature of at least 50° C., optionally in a range of 50° C. to 950° C., alternatively 100° C. to 250° C., alternatively 250° C. to 350° C., alternatively 350° C. to 450° C., alternatively 450° C. to 550° C., alternatively 550° C. to 650° C., alternatively 650° C. to 750° C., alternatively 750° C. to 850° C., alternatively 850° C. to 950° C., or a combination of these ranges. In some embodiments, the thermal treatment may be applied for a time period of 0.1 to 120 minutes.

In some embodiments one or more processing steps described above may be performed using roll-to-roll methods wherein the electrically conductive layer or current collector is in the form of a rolled film, e.g., a roll of metal foil, mesh, or fabric.

### Battery Features

The preceding description relates primarily to the anode/negative electrode of a lithium-ion battery (LIB). The LIB typically includes a cathode/positive electrode, an electrolyte and a separator (if not using a solid-state electrolyte). As is well known, batteries can be formed into multilayer stacks of anodes and cathodes with an intervening separator. Alternatively, anode/cathode stacks can be formed into a so-called jelly-roll. Such structures are provided into an appropriate housing having desired electrical contacts.

### Cathode

Positive electrode (cathode) materials include, but are not limited to, lithium metal oxides or compounds (e.g., LiCoO₂, LiFePO₄, LiMnO₂, LiNiO₂, LiMn₂O₄, LiCoPO₄, LiNiₓCo_{y}Mn_{z}O₂, LiNiₓCo_{y}Al_{z}O₂, LiFe₂(SO₄)₃, or Li₂FeSiO₄), carbon fluoride, metal fluorides such as iron fluoride (FeF₃), metal oxide, sulfur, selenium and combinations thereof. Cathode active materials are typically provided on, or in electrical communication with, an electrically conductive cathode current collector.

### Current Separator

The current separator allows ions to flow between the anode and cathode but prevents direct electrical contact. Such separators are typically porous sheets. Non-aqueous lithium-ion separators are single layer or multilayer polymer sheets, typically made of polyolefins, especially for small batteries. Most commonly, these are based on polyethylene or polypropylene, but polyethylene terephthalate (PET) and polyvinylidene fluoride (PVdF) can also be used. For example, a separator can have >30% porosity, low ionic resistivity, a thickness of ˜10 to 50 μm and high bulk puncture strengths. Separators may alternatively include glass materials, ceramic materials, a ceramic material embedded in a polymer, a polymer coated with a ceramic, or some other composite or multilayer structure, e.g., to provide higher mechanical and thermal stability.

### Electrolyte

The electrolyte in lithium ion cells may be a liquid, a solid, or a gel. A typical liquid electrolyte comprises one or more solvents and one or more salts, at least one of which includes lithium. During the first few charge cycles (sometimes referred to as formation cycles), the organic solvent and/or the electrolyte may partially decompose on the negative electrode surface to form an SEI (Solid-Electrolyte-Interphase) layer. The SEI is generally electrically insulating but ionically conductive, thereby allowing lithium ions to pass through. The SEI may lessen decomposition of the electrolyte in the later charging cycles.

Some non-limiting examples of non-aqueous solvents suitable for some lithium ion cells include the following: cyclic carbonates (e.g., ethylene carbonate (EC), fluoroethylene carbonate (FEC), propylene carbonate (PC), butylene carbonate (BC) and vinylethylene carbonate (VEC)), vinylene carbonate (VC), lactones (e.g., gamma-butyrolactone (GBL), gamma-valerolactone (GVL) and alpha-angelica lactone (AGL)), linear carbonates (e.g., dimethyl carbonate (DMC), methyl ethyl carbonate (MEC, also commonly abbreviated EMC), diethyl carbonate (DEC), methyl propyl carbonate (MPC), dipropyl carbonate (DPC), methyl butyl carbonate (NBC) and dibutyl carbonate (DBC)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitriles (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), organic compounds containing an S═O group (e.g., dimethyl sulfone and divinyl sulfone), and combinations thereof.

Non-aqueous liquid solvents can be employed in combination. Examples of these combinations include combinations of cyclic carbonate-linear carbonate, cyclic carbonate-lactone, cyclic carbonate-lactone-linear carbonate, cyclic carbonate-linear carbonate-lactone, cyclic carbonate-linear carbonate-ether, and cyclic carbonate-linear carbonate-linear ester. In some embodiments, a cyclic carbonate may be combined with a linear ester. Moreover, a cyclic carbonate may be combined with a lactone and a linear ester. In some embodiments, the weight ratio, or alternatively the volume ratio, of a cyclic carbonate to a linear ester is in a range of 1:9 to 10:1, alternatively 2:8 to 7:3.

A salt for liquid electrolytes may include one or more of the following non-limiting examples: LiPF₆, LiBF₄, LiClO₄ LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃ (iso-C₃F₇)₃, LiPF₅(iso-C₃F₇), lithium salts having cyclic alkyl groups (e.g., (CF₂)₂(SO₂)₂ₓLi and (CF₂)₃(SO₂)₂ₓLi), LiFSI (lithium bis(fluorosulfonyl)imide), LiTDI (lithium 4,5-dicyano-2-(trifluoromethyl)imidazole), and combinations thereof.

In some embodiments, the total concentration of salt in a liquid non-aqueous solvent (or combination of solvents) is at least 0.3 M, alternatively at least 0.7M. The upper concentration limit may be driven by a solubility limit and operational temperature range. In some embodiments, the concentration of salt is no greater than about 2.5 M, alternatively no more than about 1.5 M. In some embodiments, the electrolyte may include a saturated solution of a lithium salt and excess solid lithium salt.

In some embodiments, the battery electrolyte includes a non-aqueous ionic liquid and a lithium salt. Additives may be included in the electrolyte to serve various functions such as stabilizing the battery. For example, additives such as polymerizable compounds having an unsaturated double bond may be added to stabilize or modify the SEI. Certain amines or borate compounds may act as cathode protection agents. Lewis acids can be added to stabilize fluorine-containing anion such as PF₆. Safety protection agents include those to protect overcharge, e.g., anisoles, or act as fire retardants, e.g., alkyl phosphates.

A solid electrolyte may be used without the separator because it serves as the separator itself. It is electrically insulating, ionically conductive, and electrochemically stable. In the solid electrolyte configuration, a lithium containing salt, which could be the same as for the liquid electrolyte cells described above, is employed but rather than being dissolved in an organic solvent, it is held in a solid polymer composite. Examples of solid polymer electrolytes may be ionically conductive polymers prepared from monomers containing atoms having lone pairs of electrons available for the lithium ions of electrolyte salts to attach to and move between during conduction, such as polyvinylidene fluoride (PVDF) or chloride or copolymer of their derivatives, poly(chlorotrifluoroethylene), poly(ethylene-chlorotrifluoroethylene), or poly(fluorinated ethylene-propylene), polyethylene oxide (PEO) and oxymethylene linked PEO, PEO-PPO-PEO crosslinked with trifunctional urethane, poly(bis(methoxy-ethoxy-ethoxide))-phosphazene (MEEP), triol-type PEO crosslinked with difunctional urethane, poly((oligo)oxyethylene)methacrylate-co-alkali metal methacrylate, polyacrylonitrile (PAN), polymethylmethacrylate (PMMA), polymethylacrylonitrile (PMAN), polysiloxanes and their copolymers and derivatives, acrylate-based polymer, other similar solvent-free polymers, combinations of the foregoing polymers either condensed or crosslinked to form a different polymer, and physical mixtures of any of the foregoing polymers. Other less conductive polymers that may be used in combination with the above polymers to improve the strength of thin laminates include: polyester (PET), polypropylene (PP), polyethylene naphthalate (PEN), polyvinylidene fluoride (PVDF), polycarbonate (PC), polyphenylene sulfide (PPS), and polytetrafluoroethylene (PTFE). Such solid polymer electrolytes may further include a small amount of organic solvent such as those listed above. The polymer electrolyte may be an ionic liquid polymer. Such polymer-based electrolytes can be coated using any number of conventional methods such as curtain coating, slot coating, spin coating, inkjet coating, spray coating or other suitable method.

In some embodiments, the original, non-cycled anode may undergo structural or chemical changes during electrochemical charging/discharging, for example, from normal battery usage or from an earlier “electrochemical formation step”. As is known in the art, an electrochemical formation step is commonly used to form an initial SEI layer and involves relatively gentle conditions of low current and limited voltages. The modified anode prepared in part from such electrochemical charging/discharging cycles may still have excellent performance properties, despite such structural and/or chemical changes relative to the original, non-cycled anode. In some embodiments, the lithium storage layer of the cycled anode may no longer appear as a continuous layer, and instead, appear as separated pillars or islands, generally with a height-to-width aspect ratio of less than 2. While not being bound by theory, in the case of amorphous silicon, it may be that small amounts delaminate upon cycling at high stress areas. Alternatively, or in addition, it may be that structural changes upon lithiation and delithiation are non-symmetrical resulting in such islands or pillars.

In some embodiments, electrochemical cycling conditions may be set to utilize only a portion of the theoretical charge/discharge capacity of silicon (3600 mAh/g). In some embodiments, electrochemical charging/discharging cycles may be set to utilize 400-600 mAh/g, alternatively 600-800 mAh/g, alternatively 800-1000 mAh/g, alternatively 1000-1200 mAh/g, alternatively 1200-1400 mAh/g, alternatively 1400-1600 mAh/g, alternatively 1600-1800 mAh/g, alternatively 1800-2000 mAh/g, alternatively 2000-2200 mAh/g, alternatively 2200-2400 mAh/g, alternatively 2400-2600 mAh/g, alternatively 2600-2800 mAh/g, alternatively 2800-3000 mAh/g, alternatively 3000-3200 mAh/g, alternatively 3200-3400 mAh/g, or any combination of ranges thereof.

Although the present anodes have been discussed with reference to batteries, in some embodiments the present anodes may be used in hybrid lithium ion capacitor devices.

Still further embodiments herein include the following enumerated embodiments.
1. An anode for an energy storage device, the anode comprising:
a) a current collector comprising an electrically conductive layer, the current collector comprising a first surface characterized by a first pattern and a second surface characterized by a complementary second pattern; and
b) a patterned lithium storage structure comprising a continuous porous lithium storage layer disposed over the current collector in a pattern corresponding to the first pattern.
2. The anode of embodiment 1, wherein the first surface is further characterized by a first roughness and the second surface is further characterized by a second roughness lower than the first roughness.
3. The anode of embodiment 2, wherein some of the first roughness is imparted by roughness of the electrically conductive layer in areas corresponding to the first pattern.
4. The anode according to any of embodiments 1-3, wherein the current collector further comprises a surface layer disposed over the electrically conductive layer.
5. The anode of embodiment 4, wherein the surface layer is provided in a pattern corresponding to the first pattern.
6. The anode of embodiment 4 or 5, wherein some of the first roughness is imparted by roughness of the surface layer in areas corresponding to the first pattern.
7. The anode according to any of embodiments 1-6, wherein the first surface is characterized by a first surface chemical composition and the second surface is characterized by a second surface chemical composition different than the first surface chemical composition.
8. The anode according to any of embodiments 4-7, wherein the surface layer comprises a transition metal compound.
9. The anode of embodiment 8, wherein the transition metal compound comprises an oxometallate.
10. The anode according to any of embodiments 4-9, wherein the surface layer comprises a transition metal silicide.
11. The anode according to any of embodiments 4-10, wherein the surface layer comprises titanium, vanadium, chromium, manganese, iron, cobalt, nickel, copper, zinc, molybdenum, tungsten, or a silicon compound.
12. The anode according to any of embodiments 4-11, wherein the surface layer comprises lithium oxide.
13. The anode according to any of embodiments 4-12, wherein the surface layer comprises two or more sublayers each having a chemical composition different from an adjacent sublayer.
14. The anode of embodiment 13, wherein each adjacent sublayer comprises at least one transition metal independently selected from the group consisting of nickel, copper, zinc, and chromium.
15. The anode according to any of embodiments 4-14, wherein the surface layer comprises chromium in the form of chromate.
16. The anode according to any of embodiments 1-15, wherein the electrically conductive layer is in the form of a metal foil.
17. The anode according to any of embodiments 1-15, wherein the electrically conductive layer is in the form of a mesh.
18. The anode according to any of embodiments 1-17, wherein the electrically conductive layer comprises nickel, copper, titanium, or stainless steel.
19. The anode according to any of embodiments 2-18, wherein the first roughness is characterized by an R_{z}≥2.5 μm or an Rₐ≥0.25 μm.
20. The anode according to any of embodiments 2-19, wherein the second roughness is characterized by an R_{z}≤2.0 μm and an Rₐ≤0.20 μm.
21. The anode according to any of embodiments 1-20, further comprising a second lithium storage material overlaying at least a portion of the second surface.
22. The anode of embodiment 21, wherein the second surface comprises an oxide of nickel or an oxide of titanium, the first surface does not comprise an oxide of nickel or an oxide of titanium, and the second lithium storage material comprises a second continuous porous lithium storage layer comprising at least 40 atomic % silicon, germanium, or a combination thereof.
23. The anode of embodiment 21 or 22, wherein the second lithium storage material has a chemical composition and physical structure different from the continuous porous lithium storage layer.
24. The anode of embodiment 23, wherein the second lithium storage material comprises a plurality of lithium storage structures.
25. The anode of embodiment 24, wherein the lithium storage structures comprise a metal silicide and amorphous silicon.
26. The anode of embodiment 24 or 25, wherein the lithium storage structures comprise nanowires.
27. The anode of embodiment 21, wherein the second lithium storage material comprises a carbon-containing binder and particles of silicon or particles of a silicon oxide.
28. The anode of embodiment 27, wherein the second lithium storage material has a silicon content in a range of 5 to 95 weight percent.
29. The anode according to any of embodiments 1-28, wherein the current collector has a yield strength in a range of 25 to 350 MPa.
30. The anode according to any of embodiments 1-29, wherein the current collector has a yield strength in a range of 350 to 1000 MPa.
31. The anode according to any of embodiments 1-30, wherein the continuous porous lithium storage layer has a total content of silicon, germanium, or a combination thereof, of at least 40 atomic %.
32. The anode according to any of embodiments 1-31, wherein the continuous porous lithium storage layer includes less than 10 atomic % carbon.
33. The anode according to any of embodiments 1-32, wherein the continuous porous lithium storage layer is substantially free of nanostructures.
34. The anode according to any of embodiments 1-33, wherein the continuous porous lithium storage layer comprises at least 80 atomic % of amorphous silicon.
35. The anode of embodiments 34, wherein the density of the continuous porous lithium storage layer is in a range of 1.1 to 2.25 g/cm³.
36. The anode according to any of embodiments 1-35, wherein the continuous porous lithium storage layer has an average thickness of at least 5 microns.
37. The anode according to any of embodiments 4-36, wherein the surface layer has a thickness in a range of 0.005 to 2.0 microns.
38. The anode according to any of embodiments 1-37, wherein the second surface of the current collector further comprises an adhesion inhibition layer overlaying the electrically conductive layer.
39. The anode according to any of embodiments 1-38, wherein the second surface of the current collector further comprises an electrically insulative layer overlaying the electrically conductive layer.
40. The anode according to any of embodiments 1-39, wherein the second surface of the current collector further comprises a planarizing layer overlaying the electrically conductive layer.
41. The anode according to any of embodiments 1-40, wherein the second surface of the current collector further comprises an expansion confinement structure.
42. The anode of embodiment 41, wherein the expansion confinement structure comprises a metal and has an average height of at least 50% of the average thickness of the continuous porous lithium storage layer.
43. The anode according to any of embodiments 1-42, wherein a total area of the continuous porous lithium storage layer comprises at least 30% of the anode area.
44. The anode according to any of embodiments 1-43, wherein the continuous porous lithium storage layer occupies at least 30% and less than 95% of a combined area of the first and second surfaces of the current collector.
45. The anode according to any of embodiments 1-44, wherein the first pattern includes at least one lateral dimension less than 500 microns in length.
46. The anode according to any of embodiment 1-45, wherein the continuous porous lithium storage layer comprises one or more regions having at least one lateral dimension less than 500 microns in length.
47 The anode of embodiment 46, wherein the one or more regions are separated by a lateral distance of at least 5 microns.
48. The anode of embodiment 46 or 47, wherein the one or more regions are in the form of lines or islands.
49. A lithium-ion battery comprising an anode according to any of embodiments 1-48.
50. A method of making an anode for use in an energy storage device, the method comprising:
providing a current collector comprising an electrically conductive layer, the current collector comprising a first surface characterized by a first pattern and a second surface characterized by a complementary second pattern; and
forming, by chemical vapor deposition, a continuous porous lithium storage layer disposed over the current collector in a pattern corresponding to the first pattern, wherein the chemical vapor deposition includes exposing the current collector to a lithium storage material precursor gas.
51. The method of embodiment 50, wherein the lithium storage material precursor gas comprises silane or germane, and the continuous porous lithium storage layer has a total content of silicon, germanium, or a combination thereof, of at least 40 atomic %.
52. The method of embodiment 50 or 51, wherein the second surface comprises a material that inhibits formation or adhesion of the continuous porous lithium storage layer on the second surface.
53. The method according to any of embodiments 50-52, wherein the first surface is further characterized by a first roughness and the second surface is further characterized by a second roughness lower than the first roughness.
54. The method according to any of embodiments 50-53, wherein the current collector further comprises a surface layer disposed over electrically conductive layer.
55. The method of embodiment 54, wherein the surface layer is provided in a pattern corresponding to the first pattern.
56. The method according to any of embodiments 50-55, wherein the first surface is characterized by a first surface chemical composition and the second surface is characterized by a second surface chemical composition different than the first chemical composition.
57. The method according to any of embodiments 54-56, wherein the surface layer comprises a transition metal compound.
58. The method of embodiment 57, wherein the transition metal compound comprises an oxometallate.
59. The method according to any of embodiments 54-58, wherein the surface layer comprises a transition metal silicide.
60. The method according to any of embodiments 54-59, wherein the surface layer comprises titanium, vanadium, chromium, manganese, iron, cobalt, nickel, copper, zinc, molybdenum, tungsten, or a silicon compound.
61. The method according to any of embodiments 54-60, wherein the surface layer comprises lithium oxide.
62. The method according to any of embodiments 54-61, wherein the surface layer comprises two or more sublayers each having a chemical composition different from an adjacent sublayer.
63. The method of embodiment 62, wherein each adjacent sublayer comprises at least one transition metal independently selected from the group consisting of nickel, copper, zinc and chromium.
64. The method according to any of embodiments 54-63, wherein the surface layer comprises chromium in the form of chromate.
65. The method according to any of embodiments 50-64, wherein the electrically conductive layer is in the form of a metal foil.
66. The method according to any of embodiments 50-64, wherein the electrically conductive layer is in the form of a mesh.
67. The method according to any of embodiments 50-66, wherein the electrically conductive layer comprises nickel, copper, titanium, or stainless steel.
68. The method according to any of embodiments 53-67, wherein the first roughness is characterized by an R_{z}≥2.5 μm or Rₐ≥0.25 μm.
69. The method according to any of embodiments 53-68, wherein the second roughness is characterized by an R_{z}≤2.0 μm and Rₐ≤0.20 μm.
70. The method according to any of embodiments 50-69, wherein the continuous porous lithium storage layer includes less than 10 atomic % carbon.
71. The method according to any of embodiments 50-70, wherein the continuous porous lithium storage layer is substantially free of nanostructures.
72. The method according to any of embodiments 50-71, wherein the continuous porous lithium storage layer comprises at least 80 atomic % of amorphous silicon.
73. The method of embodiment 72, wherein the density of the continuous porous lithium storage layer is in a range of 1.1 to 2.25 g/cm³.
74. The method according to any of embodiments 50-73, wherein the continuous porous lithium storage layer has an average thickness of at least 5 microns.
75. The method according to any of embodiments 54-74, wherein the surface layer has a thickness in a range of 0.005 to 2.0 microns.
76. The method according to any of embodiments 50-75, wherein a total area of the continuous porous lithium storage layer comprises at least 30% of the anode area.
77. The method according to any of embodiments 50-76, wherein the continuous porous lithium storage layer occupies at least 30% and less than 95% of a combined area of the first and second surfaces of the current collector.
78. The method according to any of embodiments 50-77, wherein the first pattern includes at least one lateral dimension less than 500 microns in length.
79. The method according to any of embodiment 50-78, wherein the continuous porous lithium storage layer comprises one or more regions having at least one lateral dimension less than 500 microns in length.
80 The method of embodiment 79, wherein the one or more regions are separated by a lateral distance of at least 5 microns.
81. The method according to any of embodiments 50-80, further comprising providing a current collector precursor comprising an electrically conductive layer and treating the electrically conductive layer to form the first surface and the second surface, thereby forming the current collector.
82. The method of embodiment 81, wherein the treating comprises oxidation of the electrically conductive layer to form a metal oxide.
83. The method of embodiment 82, further comprising i) forming a patterned resist over the metal oxide, the patterned resist corresponding to the first pattern; ii) etching or dissolving areas of metal oxide not covered by the patterned resist; and iii) and removing the patterned resist.
84. The method of embodiment 82, further comprising printing of a chemical oxidant in a pattern corresponding to the first pattern.
85. The method of embodiment 82, further comprising, prior to oxidation, applying a pattern of oxidation resistant material corresponding to the second pattern.
86. The method of embodiment 81, wherein treating comprises depositing a surface layer over the electrically conductive layer.
87. The method of embodiment 86, wherein the surface layer comprises two or more sublayers.
88. The method of embodiment 86 or 87, further comprising electroplating, electroless plating, or immersion coating to deposit at least a portion of the surface layer.
89. The method according to any of embodiments 86-88, further comprising, prior to deposition, applying a resist in a pattern corresponding to the second pattern, wherein depositing the surface layer over the electrically conductive layer comprises depositing at least a portion of the surface layer in a pattern corresponding to the first pattern.
90. The method of embodiment 89, further comprising removing the resist.
91. The method of embodiment 86 or 87, further comprises printing a surface layer precursor material in a pattern corresponding to the first pattern.
92. The method of embodiment 86 or 87, further comprising printing a chemical etchant to remove at least a portion of the surface layer in a pattern corresponding to the second pattern.
93. The method of embodiment 86 or 87, further comprising applying etch resistant material in a pattern corresponding to the first pattern and etching at least a portion of the surface layer in a pattern corresponding to the second pattern.
94. The method according to any of embodiments 81-93, further comprising applying an adhesion inhibition layer over the electrically conductive layer in a pattern corresponding to the second pattern.
95. The method according to any of embodiments 81-94, further comprising applying an electrically insulative layer over the electrically conductive layer in a pattern corresponding to the second pattern.
96. The method according to any of embodiments 81-95, further comprising applying an expansion confinement structure over the electrically conductive layer in a pattern corresponding to the second pattern.
97. The method according to any of embodiments 81-96, wherein the treating further comprises roughening the surface of the electrically conductive layer.
98. The method of embodiment 97, wherein the roughening comprises physical abrasion or ablation of the electrically conductive layer or of a surface layer.
99. The method of embodiment 97 or 98, wherein the roughening comprises thermal, chemical, or electrochemical roughening of the electrically conductive layer or surface layer.
100. The method of embodiment 97, wherein the roughening comprises depositing a roughening layer over the electrically conductive layer.
101. The method of embodiment 100, wherein the depositing of the roughening layer comprises electroplating or electroless plating.
102. The method according to any of embodiments 81-101, wherein the treating further comprises smoothing the second surface.
103. The method of embodiment 102, wherein the smoothing comprises mechanical polishing, chemical polishing, or electropolishing.
104. The method of embodiment 102, wherein the smoothing comprises depositing a planarizing layer in a pattern corresponding to the second pattern.
105. The method according to any of embodiments 81-104, wherein the electrically conductive layer is in the form of a metal foil, a metal mesh, or a metal coating on an insulating substrate.
106. The method of embodiment 105, wherein the electrically conductive layer comprises copper, nickel, titanium, or stainless steel.
107. The method according to any of embodiments 50-106, further comprising forming by chemical vapor a plurality of lithium storage structures disposed over the second surface.
108. The method of embodiment 107, wherein the lithium storage structures comprise a metal silicide and amorphous silicon.
109. The method of embodiment 107 or 108, wherein the lithium storage structures comprise nanowires.
110. The method according to any of embodiments 107-109, wherein the second surface comprises zero-valent nickel metal.
111. The method according to any of embodiments 107-110, wherein forming the plurality of lithium storage structures occurs concurrently with forming the continuous porous lithium storage layer.
112. The method according to any of embodiments 50-106, wherein the continuous porous lithium storage layer is a first continuous porous lithium storage layer, the method further comprising forming, by chemical vapor deposition, a second continuous porous lithium storage layer disposed over at least a portion of the second surface of the current collector.
113. The method of embodiment 112, wherein at least a portion of the second surface comprises an oxide of nickel or an oxide of titanium, the first surface does not include an oxide of nickel or an oxide of titanium, and wherein forming the second continuous porous lithium storage layer occurs concurrently with forming the first continuous porous lithium storage layer.
114. The method according to any of embodiments 50-106, further comprising depositing a functional composition over at least a portion of the second surface.
115. The method of embodiment 114, wherein the functional composition is further deposited over at least a portion of the continuous porous lithium storage layer.
116. The method of embodiment 114 or 115 wherein the functional composition is deposited by screen printing, inkjet printing, gravure printing, offset printing, flexographic printing, curtain coating, spray coating, spin coating, or slot die coating.
117. The method according to any of embodiments 117-116, wherein the functional composition comprises a second lithium storage material.
118. The method of embodiment 117 wherein the second lithium storage material comprises a carbon-containing binder and particles of silicon or a silicon oxide.
119. The method of embodiment 118, wherein the second lithium storage material has a silicon content in a range of 5 to 95 weight percent.
120. The method according to any of embodiments 114-116, wherein the functional composition comprises a source of lithium ion.
121. The method according to any of embodiments 114-116, wherein the functional composition comprises an expansion confinement composition.
122. The method according to any of embodiments 114-116, wherein the functional composition comprises an electrically conductive material.
123. The method of embodiment 122 wherein the conductive material comprises metal nanowires, metal particles, a conductive polymer, a conductive metal oxide, or combinations thereof.
124. The method according to any of embodiments 50-106, wherein chemical vapor deposition further forms some lithium storage material on the second surface, the method further comprising removing at least a portion of the lithium storage material from the second surface.
125. The method according to embodiment 124, wherein the removing comprises sonication, contact with a brush, contact with a fluid jet, or flexure of the anode.
126. The method according embodiments 124 or 125, wherein the removing comprises transfer of the lithium storage material to a transfer substrate.
127. The method of embodiment 126 wherein the transfer substrate comprises an adhesive layer that receives the lithium storage material.
128. The method according to any of embodiments 124-127, wherein the removing comprises dry or wet etching.
129. An anode made by the method according to any of embodiments 50-128.
130. A lithium-ion battery comprising an anode according to embodiment 129.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the anode” includes reference to one or more anodes and equivalents thereof known to those skilled in the art, and so forth. The invention has now been described in detail for the purposes of clarity and understanding. However, it will be appreciated that certain changes and modifications may be practice within the scope of the appended claims.

All publications, patents, and patent applications cited herein are hereby incorporated by reference in their entirety for all purposes. None is admitted to be prior art.

1. An anode for an energy storage device, the anode comprising:
a) a current collector comprising an electrically conductive layer, the current collector comprising a first surface characterized by a first pattern and a second surface characterized by a complementary second pattern; and
b) a patterned lithium storage structure comprising a continuous porous lithium storage layer disposed over the current collector in a pattern corresponding to the first pattern,
wherein the continuous porous lithium storage layer has a total content of silicon, germanium, or a combination thereof, of at least 40 atomic %, and
wherein the first surface is further characterized by a first roughness and the second surface is further characterized by a second roughness lower than the first roughness.

2. (canceled)

3. The anode of claim 1, wherein at least some of the first roughness is imparted by roughness of the electrically conductive layer in areas corresponding to the first pattern.

4. The anode of claim 1, wherein the current collector further comprises a surface layer disposed over the electrically conductive layer.

5. The anode of claim 4, wherein the surface layer is provided in a pattern corresponding to the first pattern.

6. The anode of claim 5, wherein at least some of the first roughness is imparted by roughness of the surface layer in areas corresponding to the first pattern.

7. (canceled)

8. The anode of claim 4, wherein the surface layer comprises a transition metal compound.

9. The anode of claim 8, wherein the transition metal compound comprises an oxometallate or a transition metal silicide.

10. (canceled)

11. The anode of claim 4, wherein the surface layer comprises a silicon compound, titanium, vanadium, chromium, manganese, iron, cobalt, nickel, copper, zinc, molybdenum, or tungsten.

12. (canceled)

13. The anode of claim 4, wherein the surface layer comprises two or more sublayers each having a chemical composition different from an adjacent sublayer.

14-15. (canceled)

16. The anode of claim 1, wherein the electrically conductive layer is in the form of a metal foil.

17. (canceled)

18. The anode of claim 1, wherein the electrically conductive layer comprises nickel, copper, titanium, or stainless steel.

19. The anode of claim 1, wherein the first roughness is characterized by an R_{z}≥2.5 μm or an Rₐ≥0.25 μm.

20. The anode of claim 1, wherein the second roughness is characterized by an R_{z}≤2.0 μm and an Rₐ≤0.20 μm.

21. The anode of claim 1, further comprising a second lithium storage material overlaying at least a portion of the second surface.

22. (canceled)

23. The anode of claim 21, wherein the second lithium storage material has a chemical composition and physical structure different from the continuous porous lithium storage layer.

24. The anode of claim 23, wherein the second lithium storage material comprises a plurality of lithium storage structures, wherein the lithium storage structures comprise i) a metal silicide and amorphous silicon, ii) nanowires, or iii) both (i) and (ii).

25-26. (canceled)

27. The anode of claim 21, wherein the second lithium storage material comprises a carbon-containing binder and particles of silicon or particles of a silicon oxide.

28. (canceled)

29. The anode of claim 1, wherein the current collector has a yield strength in a range of 25 to 350 MPa.

30-31. (canceled)

32. The anode of claim 1, wherein the continuous porous lithium storage layer includes less than 10 atomic % carbon and is substantially free of nanostructures.

33. (canceled)

34. The anode of claim 1, wherein the continuous porous lithium storage layer comprises at least 80 atomic % of amorphous silicon and has an average thickness of at least 5 microns.

35-37. (canceled)

38. The anode of claim 1, wherein the second surface of the current collector further comprises an adhesion inhibition layer overlaying the electrically conductive layer.

39. The anode of claim 1, wherein the second surface of the current collector further comprises an electrically insulative layer overlaying the electrically conductive layer.

40. The anode of claim 1, wherein the second surface of the current collector further comprises a planarizing layer overlaying the electrically conductive layer.

41. The anode of claim 1, wherein the second surface of the current collector further comprises an expansion confinement structure, wherein the expansion confinement structure comprises a metal and has an average height of at least 50% of the average thickness of the continuous porous lithium storage layer.

42-43. (canceled)

44. The anode of claim 1, wherein the continuous porous lithium storage layer occupies at least 30% and less than 95% of a combined area of the first and second surfaces of the current collector.

45. (canceled)

46. The anode of claim 1, wherein the continuous porous lithium storage layer comprises one or more regions having at least one lateral dimension less than 500 microns in length.

47. The anode of claim 46, wherein the one or more regions are separated by a lateral distance of at least 5 microns.

48. The anode of claim 46, wherein the one or more regions are in the form of lines or islands.

49. (canceled)
